(19) United States
(12) Patent Application Publication
(10) Pub. No.: US 2003/0214574 A1
(43) Pub. Date: Nov. 20, 2003

(54) System and method for providing ceremonial occasion services

(75) Inventor: Nozomu Saruhashi, Osaka (JP)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Ginganet Co., Ltd.

(21) Appl. No.: 10/437,639

(22) Filed: May 14, 2003

(30) Foreign Application Priority Data
May 14, 2002 (JP) JP 2002-139159

(51) Int. Cl. H04N 7/14

(52) U.S. Cl. 348/14.01

(57) ABSTRACT

To provide ceremonial occasion services which enables for guests present in the hall to visually recognize each online guest, and simultaneously, for each online guest to visually recognize the hall and other online guest, and thus to provide a similar sensation to the case where each online guest attends and seats together with them at the hall.

Web server (20), mail server (22), communication server (24), hall terminal (30), MC terminal (40), front desk terminal (50), waiting room terminal (60) etc. are connected via network and connected with Internet (1) through a router (28). By accessing the above by using online guest terminals (81), (82), . . . having a videophone function, it is possible to attend a ceremony via online. In the hall, since display (32) and speaker (34) are provided, the image and sound of each online guest are displayed.

In addition, the image and sound within the hall are collected by multiple cameras (36) and microphones (38), synthesized with the image and sound of each online terminal and then allotted onto each online terminal.

### BACKGROUND OF THE INVENTION

1. Field of the Invention

The present invention relates to a method to providing services for ceremonies of marriage, funeral, etc., especially to a system and method for providing ceremonial occasion services enabling to attend at a ceremony via communication lines such as telephone line, internet, etc.

2. Description of the Prior Art

Conventionally, a person who wants to attend a ceremonial occasion such as marriage, funeral, etc. should go to the place where a ceremony is held. Therefore, when a person is in the distance or is too busy to have a sufficient time to go there, the person reluctantly fails to attend the ceremonies. Further, in general, the hall for a ceremony occasions is prepared based on the number of persons who have replied in advance to attend the ceremony, thus it is difficult for a person to attend a ceremony without advance notice. Further, when a person of fame is invited, there have been many problems such as the difficulty in expecting the number of attendants, the difficulty in determining a hall, the necessity to secure an excess of reserve seats, and unnecessary cost incurrence.

In order to solve such problems, Japanese patent laid-open No. 2002-49711 discloses an attendance system of cyber ceremonial hall which enables to watch the ceremony in real time.

The system consists in installing a host computer provided with a video camera and a microphone in the hall of a ceremony and transmitting in real time the image and sound of the ceremony through a Web server onto an internet online terminal designated by the ceremony host, by which an online guest in the distance can watch the ceremony and any message from the online guest can be released in the hall.

Nevertheless, in such conventional system, image and sound of the hall is transmitted in one-way to an online guest. Each online guest can be recognized by persons in the hall only when a character or voice message of the online guest is released in the hall. In general, since there is no means for visual recognition of each online guest, there is no sensation that the online guest attends together the ceremony. Further, since there is no means that an online guest can visually recognize other online guest, there is also no sensation that other online guest attends together the ceremony. Therefore, although many online guest attend together the ceremony, it is difficult to get a sensation that many guests attend together the ceremony and to promote the ceremonial atmosphere.

Therefore, an important object of the present invention is to provide ceremonial occasion services which enable for guests present in the hall to visually recognize each online guest, as well as which enable for each online guest to visually recognize other online guest, and to provide a similar sensation to the case where each online guest attends and seats together with them at the hall.

### SUMMARY OF THE INVENTION

Claim 1 describes a system for providing ceremonial occasion services enabling to attend at a ceremony via online by using an online terminal unit having a videophone function, characterized by that it comprises:

a hall image and sound acquisition means for obtaining image and sound of a hall in which said ceremony is held,

a hall display means for displaying image and sound of a person who attends said ceremony via online within the hall,

a guest acceptance means for accepting the attendance of an online guest who wants to attend the ceremony via online, and

a communication means having a function of connecting as an online guest an online terminal used by the online guest who has been accepted by said guest acceptance means, a function of receiving the image and sound of each online guest transmitted from each online terminal connected as said online guest, a first-synthesis function of synthesizing the above received image and sound of each online guest, a function of transmitting the image and sound synthesized by the above first-synthesis function onto said hall display means, a function of receiving the image and sound of the hall transmitted from said hall image and sound acquisition means, a second-synthesis function of synthesizing the above received image and sound of hall and the above received image and sound of each online guest, a function of allotting the image and sound synthesized by the above second-synthesis function onto each online terminal connected as an online guest.

Thereby, when an accepted online guest is connected to the hall, image and sound prepared by synthesizing the image and sound of each online guest is displayed on the hall display means, and image and sound prepared by synthesizing the image and sound of the hall and the image and sound of each online guest is displayed on the online terminal of each online guest. Therefore, it is possible to provide ceremonial occasion services under a similar atmosphere to the case that each online guest are present at the hall to attend the ceremony.

Claim 2 describes a system for providing ceremonial occasion services according to claim 1, characterized in that it comprises a visitor acceptance means for accepting a visitor who watches said ceremony via online, and

said communication means has a function of connecting as an online visitor an online terminal used by the visitor accepted by the above visitor acceptance means and a function of allotting the image and sound synthesized by said second-synthesis function onto each online terminal connected as an online visitor.

Thereby, when an accepted online visitor is connected to the hall, image and sound prepared by synthesizing the image and sound of each online guest is displayed on the online terminal of each online visitor. Therefore, it is possible to provide ceremonial occasion services which can accept congratulation or condolence from more people.

Further, by installing a function of accepting a message of congratulation or condolence from an online terminal of each online visitor, it is possible to accept messages of congratulation or condolence from more people.

Further, by installing a function of accepting a donation for congratulation or funeral expenses from an online terminal of each online visitor, it is possible to accept more donations from more people.

Claim 3 describes a system for providing ceremonial occasion services according to claim 1, characterized in that a reception room terminal having a videophone function is provided in a reception room for guests of said ceremony, and a function of connecting an online terminal used by the accepted online guest with said reception room terminal, a function of receiving image and sound of each reception room connector which are transmitted from each online terminal connected with said reception room terminal, a third-synthesis function of synthesizing the above received image and sound of each reception room connector, a function of transmitting the image and sound synthesized by the third-synthesis function onto said reception room terminal, a function of receiving the image and sound of the reception room transmitted from the reception room terminal, a fourth-synthesis function of synthesizing the above received image and sound of the reception room and the above received image and sound of each reception room connector, a function of allotting the image and sound synthesized by the fourth-synthesis function to each online terminal connected with said reception room terminal.

Thereby, when an accepted online guest is connected to the reception room, image and sound prepared by synthesizing the image and sound of each reception room connector is displayed on the reception room terminal, and image and sound prepared by synthesizing the image and sound of the reception room and the image and sound of each reception room connector is displayed on the online terminal of each reception room connector. Further, before entering the hall, each online guest can converse with a guest present in the reception room via a reception room terminal or with other reception room connector. Therefore, it is possible to provide ceremonial occasion services under a similar atmosphere to the case that each online guest are present at the hall to attend the ceremony.

Claim 4 describes a system for providing ceremonial occasion services enabling to attend at a ceremony via online by using an online terminal unit having a videophone function, characterized by that it comprises:

a hall image and sound acquisition means for obtaining image and sound of a hall where said ceremony is held,

a hall display means for displaying, at the hall, image and sound of a person who attends said ceremony via online,

an guest acceptance means for accepting the attendance of an online guest who want to attend the ceremony via online, and

a communication means having a function of connecting as an online guest each online terminal used by each online guest who has been accepted by said guest acceptance means, a function of receiving the image and sound of each online guest transmitted from each online terminal connected as said online guest, a function of transmitting the above received image and sound of each online guest onto said hall display means, a function of receiving the image and sound of the hall transmitted from said hall image and sound acquisition means, a function of allotting the above received image and sound onto each online terminal connected as an online guest, and a function of allotting the above allotted image and sound of each online guest onto other online terminal connected as an online guest,

wherein said hall display means has a first-synthesis function of synthesizing the image and sound of each online guest transmitted from said communication means, and

wherein the online terminal connected as said online guest has a second-synthesis function of synthesizing the image and sound of the hall transmitted from said communication means and the image and sound of other online guest transmitted from said communication means.

Thereby, when an accepted online visitor is connected to the hall, image and sound prepared by synthesizing the image and sound of each online guest is displayed on the hall display terminal, and image and sound prepared by synthesizing the image and sound of the hall and the image and sound of other online guest is displayed on the online terminal of each online guest. Therefore, it is possible to provide ceremonial occasion services under a similar atmosphere to the case that each online guest seats together at the hall to attend the ceremony.

Claim 5 describes a system for providing ceremonial occasion services according to claim 4, characterized in that it comprises a visitor acceptance means for accepting a visitor who watches said ceremony via online, and

said communication means has a function of connecting as an online visitor each online terminal used by each visitor accepted by said visitor acceptance means and a function of allotting the image and sound equivalent to those allotted to each online terminal connected as an online guest onto each online terminal connected as an online visitor,

wherein each online terminal connected as an online visitor has a function equivalent to the second-synthesis function which each online terminal connected as said online guest possesses.

Thereby, in addition to the invited guest of the ceremony, since it is possible to watch the image and sound of the hall and the image and sound of each online guest via online, it is possible to accept congratulation or condolence from more people.

Further, by installing a function of accepting a message of congratulation or condolence from an online terminal of each online visitor, it is possible to accept messages of congratulation or condolence from more people.

Further, by installing a function of accepting a donation for congratulation or funeral expenses from an online terminal of each online visitor, it is possible to accept more donations from more people.

Claim 6 describes a system for providing ceremonial occasion services according to claim 4, characterized in that a reception room terminal having a videophone function is provided in a reception room for guests of said ceremony, and

said communication means has a function of connecting an online terminal used by the accepted online guest with said reception room terminal, a function of receiving image and sound of each reception room connector which are transmitted from each online terminal connected with said reception room terminal, a function of transmitting the above received image and sound of each reception room connector onto said reception room terminal, a function of receiving the image and sound of the reception room transmitted from the reception room terminal, a function of allotting the above received image and sound of the reception room onto each online terminal connected with said reception room terminal, and a function of allotting the above received image and sound of the reception room connector onto other online terminal connected to said reception room terminal,

wherein said reception room terminal has a third-synthesis function of synthesizing the image and sound of each reception room connector transmitted from said communication means,

wherein each online terminal connected with said reception room terminal has a fourth-synthesis function of synthesizing the image and sound of reception room allotted from said communication means and the image and sound of each reception room connector allotted from said communication means.

Thereby, when an accepted online guest is connected to the hall, image and sound prepared by synthesizing the image and sound of each reception room connector is displayed on the reception room terminal, and image and sound prepared by synthesizing the image and sound of the reception room and the image and sound of other reception room connector is displayed on the online terminal of each reception room connector. Before entering the hall, each online guest can converse with a guest present in the reception room via a reception room terminal or with other reception room connector. Therefore, it is possible to provide ceremonial occasion services under a similar atmosphere to the case that each online guest seats together at the hall to attend the ceremony.

Claim 7 describes a system for providing ceremonial occasion services according to claim 1, characterized in that said first- and second-synthesis function has a function of changing the composition ratio of image and sound to be synthesized on the basis of the instruction from the terminal provided in the hall.

Thereby, it is possible to change a composition

Thereby, it is possible to change a composition ratio of image and sound of each online guest displayed by a hall display means or a composition ratio of image and sound of the hall and image and sound of each online guest displayed in each online terminal. For example, when an online guest performs a speech or entertainment, the image and sound of the online guest may be emphasized. Therefore, it is possible to provide ceremonial occasion services under a similar atmosphere to the case that each online guest seats together at the hall to attend the ceremony.

Claim 8 describes a system for providing ceremonial occasion services according to claim 1, characterized in that said hall image and sound acquisition means has a function of acquiring multiple sounds and images of the hall, and a function of selecting and synthesizing a specific image and sound from the above acquired multiple sounds and images based on the instruction from the terminal provided in the hall.

Thereby, it is possible to select the image and sound obtained by multiple cameras and microphones installed in the hall and then synthesize them if necessary. For example, when an online guest performs a speech or entertainment, the image and sound of the online guest may be emphasized by using camera or microphones for a speech or entertainment. For example, when a person concerned in the ceremony enters the hall, the image and sound of the concerned person may be emphasized by using camera or microphones installed around the entrance. Therefore, it is possible to provide ceremonial occasion services under a similar atmosphere to the case that each online guest seats together at the hall to attend the ceremony.

Claim 9 describes a system for providing ceremonial occasion services according to claim 1, characterized in that said online terminal comprises a call means which has a function of acquiring a position designated by a guest by means of a pointing device on the allotted screen, a function of selecting a called terminal from the above acquired position on the allotted screen, and a function of displaying a call screen onto the called terminal, and

said communication means has a function of connecting, when a guest who has been called responses the above call screen to accept a call for an individual conversation, a terminal used by a guest who wants the individual conversation with the above selected terminal which has been called.

Thereby, an online guest can access at any time and have an individual television conversation with other online guest during the ceremony since the online guest can designate the other online guest on the allotted screen by means of a pointing device to call for an individual conversation. Therefore, it is possible to provide ceremonial occasion services under a similar atmosphere to the case that each online guest seats together at the hall to attend the ceremony.

In addition, when a terminal having the same functions with a online terminal is installed in the hall, it is possible for a guest present in the hall to call an online guest to have a television conversation.

Claim 10 describes a system for providing ceremonial occasion services according to claim 9, characterized in that said call means has a function of displaying, onto the hall terminal, a call screen which shows the above acquired position on the allotted screen when said acquired position on the allotted screen corresponds to a position in the hall,

said communication means has a function of connecting, when the designated guest present in the hall responses the above call screen to accept a call for an individual interview, a terminal used by a guest who wants the individual conversation with the above hall terminal.

Thereby, an online guest can have an individual television conversation with a guest present in the hall via a terminal installed in the hall during the ceremony since the online guest designates the guest present in the hall on the allotted screen by means of a pointing device to call the guest for an individual conversation. Therefore, it is possible to provide ceremonial occasion services under a similar atmosphere to the case that each online guest seats together at the hall to attend the ceremony.

Claim 11 describes a system for providing ceremonial occasion services, according to claim 1, characterized in that the usher's desk of the ceremony hall is provided with an usher's desk terminal,

said usher's desk terminal has a function of accepting the attendance of a guest at the above ceremony hall.

Thereby, it is possible to accept the attendance of a guest at the ceremony hall, to register both of guests present in the hall and online guests and to clearly know the attendance status of all guests who attends the ceremony.

Claim 12 describes a system for providing ceremonial occasion services according to claim 11, characterized in that said usher's desk terminal has a videophone function, and said communication means has a function of connecting each online terminal with the usher's desk terminal.

Thereby, each online guest can connect his own online terminal with the usher's desk terminal to have a television conversation with an usher or information man, ask the condition of the hall or the attendance status, or call a guest present in the hall to have a conversation. Further, an usher or information man or a guest present in the hall can connect the usher's desk terminal with a specific online terminal to have a conversation or emergency contact with or leave a message to the specific online guest.

Claim 13 describes a system for providing ceremonial occasion services according to claim 1, characterized in that said guest acceptance means has a function of generating a table of invited guests in which the invited guests are registered with any personal information, a function of issuing a guest ID for a guest registered in the above table of invited guests, a function of issuing a letter of invitation which contains an URL of a Web site receiving an reply for attendance and the above issued guest ID to each invited guest registered in said table of invited guests, a function of confirming personal information of an invited guest registered in the table of invited guests when the invited guest who received the above issued letter of invitation accesses and enters the Web site having the notified URL by using the notified guest ID, and a function of registering the inputted reply of attendance or nonattendance on the table of invited guests.

Thereby, if only a host of a ceremony registers personal information of guests to be invited, the system automatically issues one unique ID for each invited guest and then a letter of invitation containing the guest ID and URL of web page for the attendance reply. Therefore, the invited guest can conveniently register his reply for attendance to the ceremony by accessing the URL using the guest ID contained in the letter of invitation.

In addition, a password peculiar to each invited guest may be contained into the guest ID. Accordingly, each invited guest can register his reply of attendance without exposure of personal information to other persons.

Claim 14 describes a system for providing ceremonial occasion services according to claim 13, said guest acceptance means has a function of registering an order for speech or entertainment of an invited guest who is registered in the table of invited guest, a function of issuing a letter of invitation in which a request for speech or entertainment to the guest who have been registered about the speech or entertainment order, and a function of registering an reply about the speech or entertainment order by the guest who has received the letter of invitation in which the request for speech or entertainment is described.

Thereby, when a host of a ceremony requests a speech or entertainment to a guest to be invited, a sentence requesting a speech or entertainment is automatically added to the letter of invitation only by registering an order for speech and entertainment in the table of invited guests. Further, since a reply of the invited guest is also automatically registered in the table of invited guests, the host or MC can easily know the state of the reply about the request, and then quickly meet the situations when the request is refused.

Claim 15 describes a system for providing ceremonial occasion services according to claim 13, characterized in that said guest acceptance means has a function of accepting, when an invited guest who has registered his reply that he would attend the ceremony accesses the Web site in which the attendance is accepted by using his guest ID, the attendance of the guest.

Thereby, only if an online guest who has registered his reply that he would attend the ceremony accesses the Web site in which the attendance is accepted by using his guest ID, the attendance to a ceremony can be made conveniently by using an online terminal.

Claim 16 describes a system for providing ceremonial occasion services according to claim 13, characterized in that said guest acceptance means has a function of sending an attendance accepting guide to an invited guest who has registered his reply that he would attend the ceremony and a function of accepting, when an attendance button provided in the above attendance accepting guide is clicked, the attendance of the invited guest.

Thereby, since an attendance accepting guide is transmitted to an invited guest who has registered his reply that he would attend, the invited guest can know when the acceptance of attendance starts. Further, the attendance to a ceremony can be made conveniently only by clicking an attendance guiding button provided in the above attendance accepting guide which the guest has received.

Claim 17 describes a system for providing ceremonial occasion services according to claim 1, characterized in that said guest acceptance means has a function of making an electronic guestbook by receiving image and sound transmitted from said each online terminal and leaving them as guest's record.

Thereby, since an electronic guestbook is made in which image and sound or video of online guests are registered, a valuable record can be made in commemoration of the attendance of each online guest who cannot sign directly in a guestbook.

Further, since it is possible to obtain image and sound or video of the face of each guest who is present at the hall by the front desk terminal having a videophone function, one electronic guestbook may be made for guests at the hall and online guests.

In addition, the image and sound or pictures transmitted from each online terminal may be attached onto the guest table in which invited guests are registered to be replayed by clicking a replay button provided in the guest table. Accordingly, since a guest table including personal information of guests as well as guestbook data is produced and the image and sound or picture of the guests can be replayed, it can be used as an electronic guestbook.

Claim 18 describes a system for providing ceremonial occasion services according to claim 1, characterized in that said guest acceptance means has a function of accepting a donation for congratulation or funeral expenses when an attendance is accepted, a function of registering the amount of the above accepted donation, a function of selecting a return present or an offered food based on the amount of the above registered donation, and a function of outputting a delivery order which delivers the above selected return present or the offered food.

Thereby, since a return present or an offered food corresponding to the amount of the above registered donation is selected, the payability of a ceremony can be ensured. Further, since the selected return present or offered food is automatically delivered to the guest, guests present at the hall have no necessity to take it with them and host or the like can economize of his labors to deliver it to the online guest.

Here, the function of selecting a return present or an offered food according to the registered donation amount may be provided with a return rate table for establishing a return rate to the donation amount and a table for selecting a return present or an offered food in which the presents or foods are graduated and registered according to the donation amount, and may have a function of calculating the return amount from the donation amount based on the return rate established in the above return rate table and a function of selecting a return present or an offered food to be given to a guest by reference of the above table for selecting a return present or an offered food. Accordingly, by establishing a return rate of a return present or an offered food to the donation amount in a return rate table, an appropriate return present or offered food to be given to a guest will be automatically selected. Further, as to the table for selecting a return present or an offered food to be given to a guest, it is possible to utilize an internet site in which a present or food can be selected according to its cost.

As to the function of selecting a return present or an offered food to be given to a guest, it is not essential to change the return present or offered food according to the donation amount, and it is possible to set the function so as to select a regular return present or food without regard to the amount or existence of donation. For example, without considering whether or how much a guest give a donation, in general, an acknowledgement of attending a funeral may be returned to guests who stays up all night at the funeral hall or attends at the funeral ceremony.

As to the function of outputting a delivery order to deliver the present or food automatically, it may be better to limit the application range only to online guests or only to guests wanting the function among guests at hall.

As to the return present or offered food, it is possible to show multiple goods in a screen and then let guests select any one of them. Accordingly, since guests can selects goods they want, it is possible to reduce waste such as a duplicate reception of same goods or a reception of unnecessary goods.

Claim 19 describes a system for providing ceremonial occasion services according to claim 1, characterized in that said guest acceptance means has a function of asking whether to want an express delivery service of the food or not to an online guest, a function of selecting, when the online guest wants the express delivery service of the food, a businessman of the express delivery service based on the address of the online guest, a function of sending the above selected businessman a delivery order which describes the address of the online guest who has replied to want an express delivery service of the food, the time when the ceremony starts and the like.

Thereby, since an online guest can receive an offered food by an express delivery service according to his selection on time when the ceremony starts, the online guest can attend a ceremony via online and have the same food as guests present at hall and it is possible to provide ceremonial occasion services under a similar atmosphere to the case that each online guest seats together at the hall to attend the ceremony.

As to the question about whether to want the express delivery services of food, it may be made when accepting the attendance, it is better to do the question before the day of a ceremony including when reply the attendance or nonattendance, if a previous arrangement is necessary.

As to the express delivery services of food, it may be better to limit the range to guests who register a donation more than a predetermined amount, or to change a food menu according to the total amount of registered donations. Accordingly, it is possible to provide an express delivery services of food with consideration of payability.

Further, it may be better to install a function of hearing the opinion of online guests with regard to the food menu. Accordingly, it is possible to give much satisfaction to online guests and reduce the waste of food received via express delivery.

Claim 20 describes a system for providing ceremonial occasion services according to claim 1, characterized in that said guest acceptance means has a function of sending an entrance guide into the ceremony hall to each online guest whose attendance has been accepted, and said communication means has a function of connecting as an online guest the online terminal of the online guest when a button for the entrance into the hall provided in the above entrance guide is clicked.

Thereby, it is possible to notify an online guest whose attendance has been accepted that the hall gets ready by displaying a screen for guiding the entrance into hall, and an online guest who has seen the screen for guiding the entrance can conveniently enter the ceremony hall of a ceremony only by clicking a button for entering the hall. ceremonial occasion services according to claim 1, characterized in that it comprise an MC terminal used by a MC (master of ceremonies) of the ceremony, and

the above MC terminal has a function of displaying a time table for proceeding the ceremony which describes the order and model sentences uttered by the MC of the above ceremony.

Thereby, since MC of the ceremony can refer to the time table describing the order of the ceremony at his MC terminal, the MC can easily and surely make progress of the ceremony and cope with the situations where a change of the order or time is necessary.

Further, since model sentences uttered by an MC are displayed at the MC table, MC can easily makes progress the ceremony even though the MC is not an expert.

Claim 22 describes a system for providing ceremonial occasion services according to claim 21, characterized in that said MC terminal has a function of displaying personal information and attendance status of guests whose attendance has been accepted.

Thereby, since an MC can confirm a brief character sketch or attendance status of an attended guest at any time via the MC terminal, the MC can make an exact and reliable introduction of the attended guest. Further, for example, in case where an MC becomes aware of the absence or delay of a guest who has prearranged to do a speech or entertainment to change the schedule, or where there remains some time and thus MC requests other guest to do a speech or entertainment, the MC can exactly and surely cope with the situation.

Claim 23 describes a system for providing ceremonial occasion services according to claim 21, characterized in that said MC terminal has a function of characterized in that said MC terminal has a function of displaying a predetermined access time of an online guest whose attendance has been accepted.

Thereby, since an MC can know the predetermined connection time of online guests via MC terminal, the MC can exactly makes progress the ceremony even though there are online guests who attend the ceremony only for a time.

Claim 24 describes a system for providing ceremonial occasion services to claim 21, characterized in that said MC terminal has a function of displaying a message registering table for registering the received messages of congratulation or condolence and a function of replaying and sending, when a replay button provided on the above displayed message registering table is clicked, the selected messages of congratulation or condolence to said communication means, and said communication means has a function of receiving the message transmitted from the above MC terminal, a function of transmitting the above received message onto said hall display means, and a function of allotting the above received message onto said each online terminal.

Thereby, since a message registering table in which received messages of congratulation or condolence are registered is displayed, it is possible for a MC to confirm the registered message for congratulation or condolence and then to release them to guests. Further, by clicking a replay button provided in a message registering table displayed in the MC terminal, the selected message is replayed and then transmitted onto a hall display means and each online terminal at the same time. Therefore, a MC can select a specific message from a message registering table by one touch manner to show it to hall guest and online guest.

Claim 25 describes a system for providing ceremonial occasion services according to claim 21, characterized in that said guest acceptance means has a function of asking said accepted guest whether he wants to do a speech or entertainment, a function of registering the reply of yes or no to the above question, and said MC terminal has a function of displaying the above registered reply.

Thereby, when a guest takes an acceptance step, the guest can automatically confirm whether he is designated so as to do a speech or entertainment and the results are displayed in a MC terminal. Therefore, in case where the a guest prearranged to do a speech or entertainment is absence or there remains some time, the MC can composedly make progress the ceremony.

Claim 26 describes a system for providing ceremonial occasion services according to claim 21, characterized in that said MC terminal has a videophone function, and said communication means has a function of connecting an online terminal with the MC terminal.

Thereby, since each online guest can connect with the MC terminal to do a television conversation with MC, it is possible to confirm the ceremony schedule or request a speech or entertainment to a non-scheduled guest. Further, the MC also connect MC terminal with a specific online terminal to confirm details of the guest's speech or entertainment, to request an adjustment of time, or to order a speech or entertainment of a non-scheduled guest.

Claim 27 describes a system for providing ceremonial occasion services according to claim 1, characterized in that it comprises a host terminal used by the host of the ceremony and said host terminal has a videophone function, and said communication means has a function of connecting an online terminal to the host terminal.

Thereby, since each online guest can connect with the host terminal to have a television conversation, it is possible to tell the host a congratulatory or funeral address personally. Further, since the host also connect the host terminal with a specific online terminal to have a television conversation, it is possible for the host to give a thanks personally to a specific online guest.

Claim 28 describes a system for providing ceremonial occasion services according to claim 1, characterized in that, as to the image allotted onto said each online terminal, it comprises a commemorative photograph recording means for recording, as commemorative photographs, images of the appointed frames from a terminal installed in the hall.

Since the image allotted to each online terminal contains both of image of the hall and images of each online guest, a commemorative photograph in which hall guests and online guests are gathered in a place can be easily recorded.

Further, in the means for recording a commemorative photograph, as to the image obtained by a hall image and sound acquisition means or images transmitted from each online terminal, it is preferable to install a function of recording as a commemorative photograph the picture of frame designated at a terminal in the hall. Accordingly, it is possible to remain individual image of a hall guest or individual image of a online guest as a commemorative photograph.

As such, without importing any special photographing device and by using images of hall camera or each online terminal camera effectively, it is possible to remain various scenes as commemorative photographs.

Claim 29 describes a system for providing ceremonial occasion services according to claim 1, characterized in that it comprises a means for recording and allotting a video album, which has a function of recording image and sound allotted onto said each online terminal as a video album and a function of allotting the above recorded video album by an on-demand manner.

Since the image and sound allotted to each online terminal contains both of the image and sound of the hall and the images and sounds of each online guest, the image and sound which capture the scenes of the ceremonial occasion in the best way are recorded as a video album, which can be downloaded by on-demand manner and then can be read. Accordingly, the host or the concerned can utilize the video album as commemorative data of the ceremonial occasion, and read at any time to get a deep impression. Further, by install a Web page in which it is possible to search ceremonial occasions which have been already held and then to read their allotted image and sound, it is possible to receive messages of congratulation or condolence and to collect donations for congratulation or condolence from more persons.

Claim 30 describes a system for providing ceremonial occasion services according to claim 1, wherein it comprises a means for accepting a message of congratulation or condolence which is provided with a table for registering the message and has a function of accepting an application of the message, a function of registering the personal information of the above registered applicant of the message onto the table for registering the message, and a function of registering the message onto the table for registering the message,

characterized in that it has a function of registering image and sound transmitted from an online terminal having a videophone function as a message of congratulation or condolence.

Thereby, it is possible to send a multimedia message including image or voice as a message of congratulation or condolence by using an online terminal having a videophone function.

Claim 31 describes a system for providing ceremonial occasion services according to claim 30, characterized in that said means for accepting a message of congratulation or condolence has a function of editing the contents of the message of congratulation or condolence.

Thereby, since a message of congratulation or condolence can be transmitted as well as the transmitted image and sound or picture can be edited via online, it is possible to conveniently produce an effective multimedia message even without any specific equipment or software to employ it as a message of congratulation or condolence.

Claim 32 describes a system for providing ceremonial occasion services according to claim 1, characterized in that it comprises a donation accepting means for accepting a donation for congratulation or funeral expenses, which is provided with a donation registering table for registering the donation and has a function of accepting an application of the above donation, a function of registering personal information of the above accepted applicant, the payment method and the amount of money onto the donation registering table, and a function of asking the applicant for payment based on the payment method registered in the above donation registering table.

Thereby, since a donation is accepted via online and then automatically collected, there is no necessity to collect money manually and any mistake by human can be prevented. Therefore, it is possible to collect the money of donation safely and reliably.

Claim 33 describes a system for providing ceremonial occasion services according to claim 32, characterized in that said donation accepting means is provided with a donation-refusal table for registering persons whose donation for congratulation or funeral expenses would be refused, and said function of accepting an application of the donation includes a function of refusing the application of the donation based on the above donation-refusal table.

Thereby, by registering persons whose donation is not wanted to accept in the donation-refusal table, it is possible to refuse automatically an application of the donation. Therefore, an acceptance of a donation can be made with consideration of any specific situation.

Claim 34 describes a system for providing ceremonial occasion services according to claim 32, characterized in that said donation accepting means has a function of delivering an appreciative letter to applicants registered on said donation registering table, a function of selecting a return present according to the amount registered in the above donation registering table, and a function of outputting a delivery order which delivers the selected return present to the applicant registered on said donation registering table.

Thereby, since an appreciative letter is automatically delivered when a donation is accepted and at the same time a return present is selected based on the amount of the donation, there is no necessity to issue a receipt manually and any omission of dispatch or any selection mistake of goods may be prevented. Therefore, it is possible to make a return present certainly.

Here, the function of selecting a return present according to the registered donation amount may be provided with a return rate table for establishing a return rate to the donation amount and a table for selecting a return present in which the presents are graduated and registered according to the donation amount, and may have a function of calculating the return amount from the donation amount registered in the donation registering table based on the return rate established in the above return rate table and a function of selecting a return present by reference of the above table for selecting a return present.

Thereby, by establishing a return rate of a return present to the donation amount in a return rate table, an appropriate return present corresponding to the accepted donation amount will be automatically selected. Further, as to the table for selecting a return present, it is possible to utilize an internet site in which a present can be selected according to its cost.

As to the function of selecting a return present according to the amount registered in a donation registering table, it is not essential to change the return present according to the donation amount, and for example, it is possible to establish the function so as to select a regular return present without regard to the amount or existence of donation as in the case of the acknowledgement of staying up all night at the funeral hall or attending at the funeral ceremony.

Claim 35 describes a system for providing ceremonial occasion services according to claim 32, characterized in that said donation accepting means has a function of finding out the total of the above requested payment amount and a function of doing the payment for the ceremony from the above total amount.

Thereby, since it is constructed to find out the total of the requested payment amount and to do the payment for the ceremony from the total amount, it is possible to unitarily manage the income and expenditure based on the donation as the financial resources, by which a sound budget management can be made. Further, it is possible to install a function of selecting a return present according to the money left after paying the expenses of the ceremony from the total amount of donation. Accordingly, since it is possible to treat the income and expenditure of the ceremonial occasion based on the donation as the financial resources after incorporating the expenses necessary for the return present in it, an economic ceremonial occasion can be made.

Claim 36 describes a system for providing ceremonial occasion services according to claim 1, characterized in that it comprises a mail sending means having a function of generating an appreciative letter attached with image and sound or picture which have been recorded at the ceremony and a function of delivering the above generated appreciative letter to guests who attended the ceremony.

Thereby, since an appreciative letter is automatically delivered to a guest who attended the ceremony, it is possible to prevent any man-made mistake such as delivery omission or the like, and thus to avoid a situation caused by lack of courtesy to a person who gave many help. Further, since the image and sound or picture of the day of a ceremony are attached to an appreciative letter, it is possible to remind the guest who received the appreciative letter of the image of the day and thus to renew the sentiment. Further, as to the image and sound or picture attached to an appreciative letter, it is possible to employ the pictures recorded by a commemorative photograph recording means or to attach as a link data the image and sound recorded by a means for recording and allotting a video album. Further, the delivery of such appreciative letter may be applied not only to all the guest who attended the ceremony but also to all the persons who were invited, or it may be applied to the appreciative letter for persons who have sent a message of congratulation or condolence or a donation for congratulation or condolence.

Claim 37 describes a system for providing ceremonial occasion services according to claim 1, characterized in that it comprises a means for ordering a non-scheduled attendance which is provided with a non-scheduled guest accepting table for accepting persons who have been designated and attend the ceremony via online, and has a function of confirming the schedule of a person registered in the above non-scheduled guest accepting table, a function of selecting a person who is capable of unexpectedly attending the ceremony based on the confirmed schedule, and a function of issuing an order for non-scheduled attendance to the above selected person, and at the same time,

said communication means has a function of connecting as an online guest, when a non-scheduled guest ordered by the above means for ordering a non-scheduled attendance attends the ceremony, the online terminal used by the non-scheduled guest.

Thereby, as to a person such as a person of fame or an entertainer who has a schedule difficult to change and thus has not been invited, it is possible to accept the online attendance of the person as a non-scheduled guest when the person can attend the ceremony as a non-scheduled guest at the day of the ceremony by reference of a non-scheduled attendance registering table.

Further, for example, by installing an online terminal having a videophone function in an office of a person of fame or an entertainer to have him/her register the time to accept a non-scheduled attendance in a non-scheduled attendance registering table, it is possible to search at the ceremony hall the non-scheduled attendance registering table to find out a person of fame or an entertainer who is free with no scheduled business and then to accept the online attendance.

Further, the non-scheduled attendance registering tables may be installed at each terminal having a videophone function, but it is preferable to concentrate and install them in a site to register name, position/post, contact, mail address, time to accept the attendance, etc. Further, as to time to accept the attendance, it is possible to search it by reference of a separate schedule book.

Claim 38 describes a system for providing ceremonial occasion services according to claim 37, characterized in that said non-scheduled guest accepting table can register a reward amount for a non-scheduled attendance of the registered person,

wherein it comprises a means for paying a reward of a non-scheduled guest which pays the reward amount registered in the above non-scheduled guest accepting table when a non-scheduled person ordered by said means for ordering a non-scheduled attendance attends the ceremony.

Thereby, since a person of fame or an entertainer who attended the ceremony can be automatically paid the reward registered in a non-scheduled attendance registering table, it is possible to develop an online appearance services at a ceremonial occasion in which a person appears on the stage via online and gets a guarantee.

Claim 39 describes a method for providing ceremonial occasion services enabling to attend at a ceremony via online by using an online terminal unit having a videophone function, characterized by that it comprises:

a step of accepting an online guest who attends said ceremony via online,

a step of connecting, as online guest, each online terminal used by the above accepted online guest,

a step of receiving image and sound of each online guest transmitted from each online terminal which has been connected as said online guest,

a first-synthesis step of synthesizing the above received image and sound of each online guest,

a step of displaying the image and sound synthesized by the above first-synthesis step function within a hall in which said ceremony is held,

a step of obtaining image and sound of the hall,

a second-synthesis step of synthesizing the above obtained image and sound of the hall and the above received image and sound of each online guest,

a step of allotting the image and sound synthesized by the above second-synthesis step onto each online terminal connected as an online guest.

Thereby, when an online guest who has completed its acceptance of attendance connects to the hall, since the image and sound obtained by synthesizing the image and sound of each online guest are displayed in the hall and the image and sound obtained by synthesizing the image and sound of the hall and the image and sound of each online guest are displayed onto the terminals of each online guest, it is possible to provide ceremonial occasion services under a similar atmosphere to the case that each online guest is present at the hall to attend the ceremony.

Claim 40 describes a method for providing ceremonial occasion services enabling to attend at a ceremony via online by using an online terminal unit having a videophone function, characterized by that it comprises a step of accepting an online guest who attends said ceremony via online, a step of connecting, as online guest, each online terminal used by the above accepted online guest, a step of receiving image and sound of each online guest transmitted from each online terminal which has been connected as said online guest, a first-synthesis step of synthesizing the above received image and sound of each online guest, a step of displaying the image and sound synthesized by the above first-synthesis step function within a hall in which said ceremony is held, a step of obtaining image and sound of the hall, a step of allotting the above obtained image and sound of the hall onto each online terminal connected as an online guest, and a step of allotting the received image and sound of each online guest onto other online terminal connected as the above online guest,

wherein each online terminal connected as said online guest has a second-synthesis step of synthesizing the above allotted image and sound of the hall and the above allotted image and sound of other online guest.

Thereby, when online guests whose attendance has been accepted connect to the hall, the image and sound of each online guest are displayed in the hall and the image and sound synthesized from the image and sound of the hall and the image and sound of other online guests are displayed in the terminals of each online guest. Therefore, it is possible to provide ceremonial occasion services under a similar atmosphere to the case that each online guest seats together at the hall to attend the ceremony.

In addition, the method for providing ceremonial occasion services comprising the steps corresponding to each means and each function of the system for providing ceremonial occasion services described in any one of claims 2, 3, 5, 6 and 7 to 38 can also achieve the same action and effects with those of each system for providing ceremonial occasion services.

The above described objects, other objects, characteristics and advantages of the present invention will be apparent from the below description of the embodiments of the invention by referencing drawings.

### BRIEF DESCRIPTIONS OF THE DRAWINGS

FIG. 1 illustrates a schematic diagram showing an embodiment of the system for providing ceremonial occasion services of the present invention.

FIG. 2 illustrates an example of a connected terminal address table of communication server.

FIG. 3 illustrates an example of system realizing the function of connecting to hall by the communication server.

FIG. 4 illustrates an example of the arrangement plan of wedding reception hall.

FIG. 5 illustrates an example of a screen allotted to online guest.

FIG. 6 illustrates an example of a screen displayed in the hall display.

FIG. 7 illustrates an example of an allotted screen when a hall guest does a speech.

FIG. 8 illustrates an example of an invited guest table.

FIG. 9 illustrates an example of a letter for invitation of a wedding reception.

FIG. 10 illustrates an example of a menu display.

FIG. 11 illustrates an example of a login screen for accepting reply of attendance.

FIG. 12 illustrates an example of a page for accepting reply of attendance at a wedding reception.

FIG. 13 illustrates an example of an accepted guest table.

FIG. 14 illustrates an example of a login screen for accepting the attendance.

FIG. 15 shows an example of an attendance accepting screen.

FIG. 16 illustrates an example of a screen after completing the acceptance of the attendance.

FIG. 17 illustrates a schematic diagram of the function of communication server to connect to waiting room.

FIG. 18 illustrates an example of screen allotted to a waiting room connector.

FIG. 19 illustrates an example of a screen for guiding the entrance into hall.

FIG. 20 illustrates an example of a guide mail for accepting the attendance.

FIG. 21 illustrate an example of a time table for MC.

FIG. 22 illustrates an example of a screen for searching wedding receptions.

FIG. 23 illustrates an example of a screen for accepting the reading, message, donation and watching.

FIG. 24 illustrates an example of a screen for accepting message for congratulation.

FIG. 25 illustrates an example of a screen for editing video.

FIG. 26 illustrates an example of a screen for editing image.

FIG. 27 illustrates an example of a message registering table.

FIG. 28 illustrates an example of a screen for accepting a donation for congratulation.

FIG. 29 illustrates an example of a donation registering table.

FIG. 30 illustrates an example of an appreciative letter for donation for congratulation.

FIG. 31 illustrates an example of a screen for accepting visitors.

FIG. 32 illustrates an example of visitor table.

FIG. 33 illustrates an example of a screen allotted onto online visitors.

FIG. 34 illustrates an example of an appreciative letter to attended guests.

FIG. 35 illustrates an example of a non-scheduled guest registering table.

FIG. 36 illustrates an example of a screen for ordering non-scheduled attendance.

In the above figure, symbols has the following meanings:

(10) system for providing ceremonial occasion services, (20) Web server, (22) mail server, (24) communication server, (28) router, (30) hall terminal, (32) hall display, (34) hall speaker, (36) hall camera, (38) hall microphone, (40) MC terminal, (50) front desk terminal, (60) waiting room terminal, (70) host terminal, (81), (82), . . . online guest terminal, (91), (92), . . . online visitor terminal.

### DETAILED DESCRIPTION OF THE PREFERRED EMBODIMENT

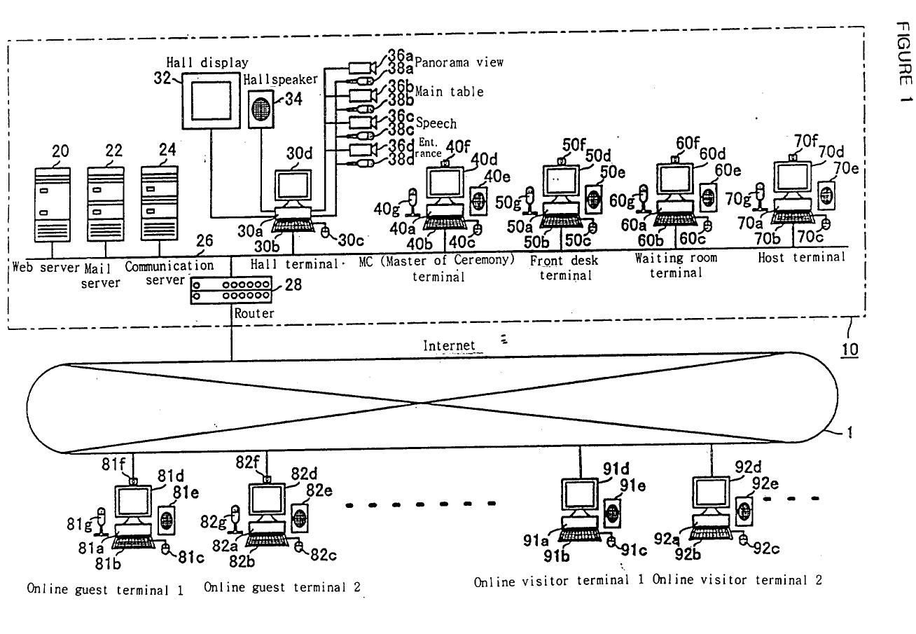

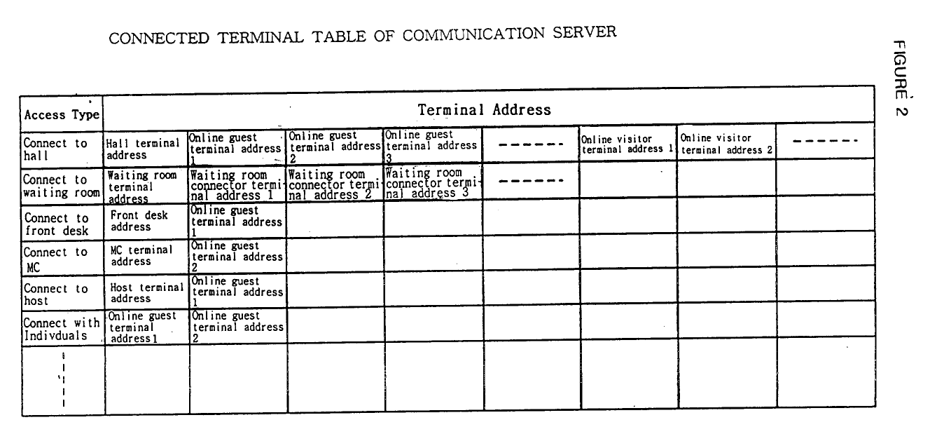

FIG. 1 is a schematic diagram showing an embodiment of the system for providing ceremonial occasion services of the present invention.

In the drawing, symbol (10) means a system for providing ceremonial occasion services, which is connected via internet with online guest terminals (81), (82), . . . used by online guests who attend the ceremony via online and online visitor terminals (91), (92), . . . used by online visitors who watch the ceremony via online.

The system for providing ceremonial occasion services comprises a Web Server (20) used as the window of the services, a Communication Server (24) which is connected with online terminals and hall terminals to provide a bi-directional communicating function by image and sound, a Hall Terminal (30) installed in a hall where a ceremony is held, an MC Terminal (40) used by an MC (Master of ceremonies), a Front Desk Terminal (50) installed at the front desk of the hall, a Waiting Room Terminal (60) installed in a Waiting Room and a Host Terminal (70) used by the host of the ceremony. These are connected to a network and connected to Internet (1) via a Router (28).

Web server (20) is a WWW sever which serves as a service window for providing ceremonial occasion services. It is possible to use various services described in below by access to a predetermined web page by means of a web browser from an online terminal.

Further, web sever is not necessarily installed within the system. For example, it may be constructed so as to do a prescribed window function by utilizing an external WWW server provided by a provider and registering the prescribed web pages, CGI programs, etc. on the WWW server of the provider.

Mail Server (22) is used in order to notify an attendance guide or an entrance guide to online terminals by means of mail.

Mail sever is also not necessarily installed within the system. For example, it may be provided with a program which requests the sending and receiving of the mails to an external mail server of a provider.

Communication server (24) connects online terminals with a hall terminal to provide a bi-directional communicating function with image and sound. Therefore, it connects multiple terminals based on the terminal addresses set on the connected terminal table as shown in the drawing and makes it possible to have a conversation with image and sound. Single address is supposed to be IP address of each terminal in the embodiment, or may designate a telephone number in case of ISDN videophone as described below.

As shown according to access type in the figure, connections by a connected terminal table includes a connection to hall which means a mutual connection of a hall terminal with online guest terminals and online visitor terminals, a connection to waiting room which means a mutual connection of a waiting room terminal with online terminals of waiting room connector who is connected to waiting room, a connection to front desk which means a connection of a front desk terminal with online guest terminals, a connection to MC which means a connection of an MC terminal with online guest terminals, a connection to host which means a connection of a host terminal with online guest terminals, and a connection with individuals which means an individual connection between designated terminals. These connections are established in a necessary number and then multiple communication function is carried out. Further, the connection to hall includes a connection with an online terminal established as an online guest by a bi-directional communication with image and sound and a connection with an online terminal established as an online visitor by allotting only the image and sound to the terminal.

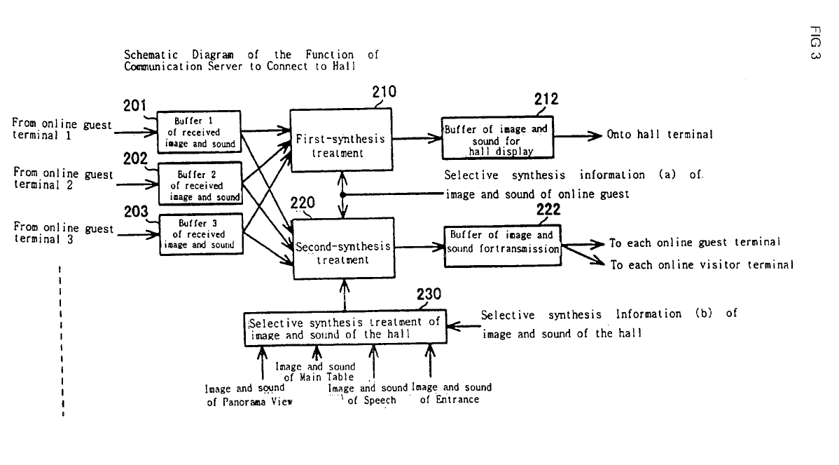

FIG. 3 shows an example of system realizing the function of connecting to hall by the communication server (24). As can be seen in the Figure, the image and sound transmitted from each online terminal are received in streaming manner and then sequentially stored in each buffer (201), (202), (203), . . . of the received image and sound. The image and sound stored in the buffer (201), (202), (203), . . . are synthesized in the first-synthesis treatment (210), and then sequentially stored in buffer (212) of image and sound for hall display. The image and sound stored in the buffer (212) of image and sound for hall display are sequentially read and then transmitted in streaming manner to a hall terminal (30).

In the context, the first-synthesis treatment (210) usually synthesizes the image and sound of each online guest in an equal rate, but is provided with a function of emphasizing image and sound of a special online guest based on the information (a) of selection and synthesis of image and sound of online guest and then synthesizing them. This is used to show an enlarged image of the online guest on the hall display, for example when the online guest performs a speech or entertainment.

In addition, as to the images and sounds of the whole view, main table, speech platform, entrance, etc. collected at the hall terminal (30), a specific image and sound is selected from the selective synthesis information of image and sound of the hall in the selective synthesis treatment (230) of image and sound of the hall, and if more than two image and sound are selected they are synthesized. In the selective synthesis treatment (230) of image and sound of the hall, the selected and synthesized image and sound of the hall are sequentially synthesized with the image and sound stored at buffers (201), (202), (203), . . . of the received image and sound in the second-synthesis treatment (220) and thus synthesized image and sound are sequentially stored at buffer (222) of image and sound for transmission. The image and sound stored at buffer (222) of image and sound for transmission are sequentially read and then allotted in streaming manner to each online guest terminal and each online visitor terminal.

As in the first-synthesis treatment (210), the second-synthesis treatment (220) usually synthesizes the image and sound of each online guest in a equal rate to the image and sound of the hall, but is provided with a function of emphasizing image and sound of a selected online guest based on the information (a) of selective synthesis of image and sound of online guest and then synthesizing them.

Further, in the course of the first-synthesis treatment (210) or second-synthesis treatment (220), it is possible to designate only a special online guest based on the information (a) of selective synthesis of image and sound of online guest and then to enlarge the image and sound of the designated online guest, but it is also possible to incorporate data about a size of the synthesized image or a division ratio of the synthesized sound into the information (a) of selective synthesis of image and sound of online guest and then to synthesize the images of each online guest into a designated size or the sounds of each online guest into a designated ratio. Therefore, it is possible to cope with the situation where multiple guests do a speech or entertainment together or the like, and thus, it is possible to provide more flexible services.

When synthesizing image and sound of each online guest, it is possible to combine them with previously appointed multimedia information such as a still or dynamic image, Telop (Television Opaque Projector), voice, background music (BGM), etc. Accordingly, various services conforming to objects can be provided.

It is usual for the selective synthesis treatment (230) of image and sound of the hall to provide the image and sound selected by the information (b) of selective synthesis of image and sound of the hall among the sounds and images obtained at the hall display (30) into a second-synthesis treatment, but it also has a function of synthesizing multiple images and sounds to supply a second-synthesis treatment. This is, for example when a hall guest do a speech or entertainment, to combine image and sound of an orator with image and sound of other hall guests in order to compare the responses of other hall guests.

Even in such case, as in the course of the first-synthesis treatment (210) or second-synthesis treatment (220), it is also possible to incorporate data about a size of the synthesized image or a division ratio of the synthesized sound into the information (a) of selective synthesis of image and sound of the hall and then to synthesize each image of the hall into a designated size or each sound of the hall into a designated ratio. Therefore, it is possible to provide more flexible services. Further, when synthesizing image and sound of the hall, it is possible to combine them with previously appointed multimedia information such as a still or dynamic image, voice, Telop, etc. Accordingly, various services conforming to objects can be provided.

The selective synthesis treatment (230) of image and sound of the hall, although it is explained as a function of the communication server (24) in the embodiment, may be installed in the hall terminal (30). In such case, since it is possible to transmit single image and sound from hall terminal (30) to the communication server (24), a load of the network can be reduced.

Hall terminal (30) is equipped with processing units (30) such as a personal computer having a videophone function with an image input interface function and a voice input interface function, keyboards (30b), mouses (30c), and displays (30d), and connected with a hall display (32) and a hall speaker (34) which display the image and sound of each online guest and a hall camera (36) and hall microphone (38) as hall image and sound acquisition means.

Onto the hall display (32) or hall speaker, the image and sound of each online guest synthesized by the first-synthesis treatment (210) is displayed.

The hall camera (36) or hall microphone (38) includes, for example, a panorama view camera (36a) and a panorama view microphone (38a) which capture the image and sound of all the hall, a main table camera (36a) and a main table microphone (38b) which capture the image and sound of the main table or altar, a speech camera (36c) and a speech microphone (38c) which capture the image and sound of a person performing a speech or entertainment, an entrance camera (36d) and an entrance microphone (38d) which capture the image and sound around the hall entrance. The images and sounds obtained by the above cameras and microphones are suitably synthesized by the selective synthesis treatment (230) of image and sound of the hall, and then synthesized with image and sound of each online guest by a second-synthesis treatment. Thereafter, the above synthesized image and sound are streamingly allotted onto each online guest terminal (81), (82), . . . and each online visitor terminal (91), (92) . . . .

Said selective synthesis treatment (a) of image and sound of online guest terminal or said selective synthesis information (b) of image and sound of the hall are produced and then transmitted to communication server (24) when a hall manager sets on a camera-microphone selecting screen (not illustrated) to be displayed on the hall display by using a keyboard (30b) or a mouse (30c).

It is usual for hall display (32) to display a synthesized image of each online guest, but it may have a function of enlarging the image of a hall guest when the guest does a speech or entertainment. Accordingly, for example in case where the hall guest doing a speech or entertainment is not well seen because the hall is too large or due to any other reasons, the above enlargement function may be combined.

Further, it is usual for hall speaker (34) to output a synthesized sound of each online guest, but it may have a function of synthesize the sound from the microphones in the hall. Accordingly, the hall microphone may combine the PA function at the hall.

Further, multiple hall display (32) or hall microphone (34) may be installed in the hall in order to remove the dead angle to any hall guest.

MC terminal (40), front desk terminal (50), waiting room terminal (60) and host terminal (70) are equipped with processing units (40a), (50a), (60a), (70a) of a personal computer having a videophone function with an image input interface and a voice input interface, keyboards (40b), (50b), (60b), (70b), mouses (40c), (50c), (60c), (70c), and displays (40d), (50d), (60d), (70d), and connected with cameras (40f), (50f), (60f), (70f) which primarily take images of MC, front desk, waiting room and host, respectively, and microphones (40g), (50g), (60g), (70g) which primarily collects voices of MC, front desk, waiting room and host, respectively.

Meanwhile, online guest terminals (81), (82), . . . used by each online guest who attends a ceremony via online, identically with a hall terminal, are equipped with processing units (81a), (82a), . . . such as a personal computer having a videophone function with an image input interface and a voice input interface, keyboards (81b) (82b), . . . , mouses (81c), (82c), . . . , and displays (81d) (82d), . . . ,and connected with cameras (81f), (82f), . . . which primarily take images of each online guest, and microphones (81g), (82g), . . . which primarily collects voices of each online guest.

Online visitor terminals (91), (92), . . . used by each online visitor who attends a ceremony via online are equipped with processing units (91a), (92a), . . . such as a personal computer having a videophone function, keyboards (91b), (92b), . . . , mouses (91c), (92c), . . . , and displays (91d), (92d), . . . .

Further, online visitor terminals (91), (92), . . . , identically with online guest terminals (81), (82), . . . , can employ a processing unit equipped with an image input interface and a voice input interface, and can use a terminal having a videophone function connected with camera or microphone.

As to a terminal having a videophone function, in the embodiment of the present invention, it is supposed to employ a computer which has a television image input function and sound input function and an Internet accessing function, a web browser for accessing to Web Server (20), and a plug in software providing a videophone function. This is to consider to systematically combine services provided by Web Server (20) with communication services provided by Communication Server (24). If there is no necessity such systematic combination, it is possible to employ a terminal unit combining a general-purpose computer having a web browser for accessing Web Server (20) and a general purpose videophone device and it is possible to provide the services even without installing any special software at the terminal unit.

As to the software providing a videophone function, it is possible to use, for example an internet videophone software in accordance with a standard of H.323 of ITU-T, in which the connection with a telephone companion is made via Internet. In such case, Communication Server (24) has essentially a calling control function, a streaming control function and CODEC for compression and expansion of image and sound in accordance with a standard of H.323. However, since they are identical with those used in MCU (Multiple Connecting Unit) of videophone conference system, detailed discussion is omitted.

In addition, as to the software providing a videophone function, it is possible to use an ISDN videophone software in accordance with a standard of H.320 of ITU-T, in which the connection with a telephone companion is made via ISDN. It is also possible to use any other videophone software based on other unique protocol. In such cases, Communication Server (24) has essentially a calling control function, a streaming control function, CODEC, etc. all of which should be in accordance with its own standard. However, it is possible to connect them by installing a gateway which performs a protocol transformation between each terminal and a communication server.

Below, functions realized by the present invention will be explained by reference with a wedding reception as an example of ceremonies.

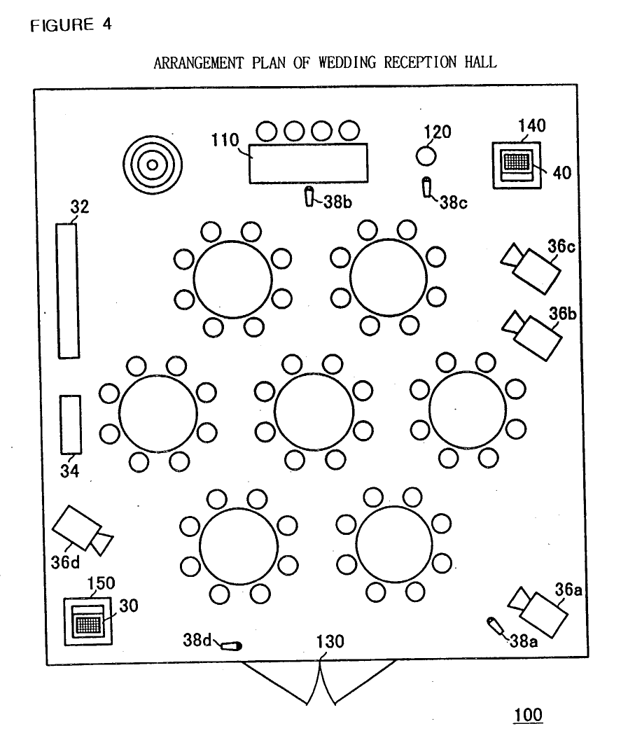

FIG. 4 shows an example of a hall of wedding reception, in which hall cameras, a hall display and a hall speaker are mounted. In the Figure, numerical symbols represent as follows: (100) wedding reception hall, (110) main table in which the bridal pair or matchmaker seats, (120) a place at which a speech or entertainment is performed, (130) a hall entrance, (140) an MC table, and (150) a seat for a hall manager.

Symbol (32) means a hall display, in which the image of each online guest is shown by a large-size screen. Further, Symbol (34) means a hall speaker, by which the voice of each online guest sounds to hall guests.

Symbol (36a) means a camera for the complete view of the hall, which takes picture of images of all the hall (110). Symbol (38a) means a microphone for all the hall, which collects sound of all the hall. Symbol (36b) means a camera for the main table, which takes picture of images of the bridal pair or the matchmaker. Symbol (38b) means a microphone for the main table, which collects sound such as conversation at the main table. Symbol (36c) means a speech camera, which takes picture of images of the place (120) at which a speech or entertainment is performed. Symbol (38c) means a speech microphone, which collects sound such as voice of speech or entertainment. Symbol (36d) means an entrance camera, which takes picture of images around the hall entrance (140). Symbol (38d) means an entrance microphone, which collects sound around the hall entrance (140).

MC terminal (30) is installed at MC table (140). During the reception, MC (master of ceremonies) can operate MC terminal to contribute to the convenience in directing the ceremony.

In addition, hall terminal (30) is installed at hall manager table (150). A hall manager will designated or select the image and sound displayed in the hall, the image and sound allotted to each online guest, display style of screen allotted to hall display, hall speaker and each online guest.

Each online guest can access a web server (20) by using a web browser in his terminal to receive the services, and image and sound are allotted to each terminal according to the setting in the connected terminal table of the communication server (24).

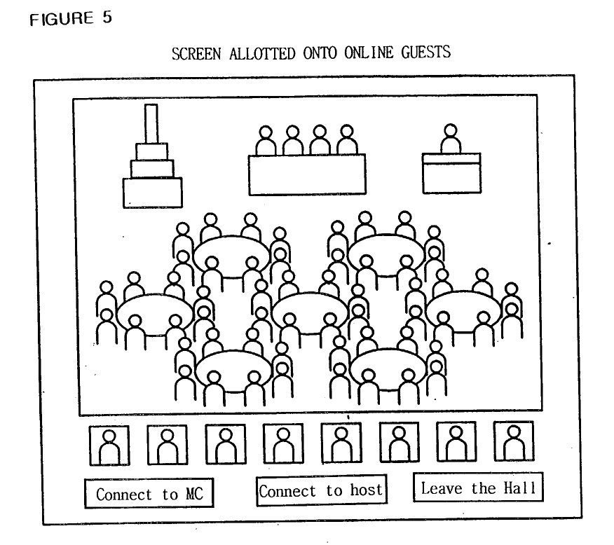

FIG. 5 shows an example of a screen allotted to each online guest. As illustrated in the figure, image from hall terminal (30) is displayed in a big size in the upper part of the screen, images of each online guest are displayed in a small size in the lower part of the screen. As such, since the images of each online guest are synthesized in a small rate to the image of the hall, it can give a sensation that each online guest attend and seats together at the hall.

At the lower screen below the images of each online guest, there is given a button for connecting to MC, a button for connecting to host and a button for exiting the hall. By clicking these buttons on the screen by each online guest, it is possible for the online guest to connect with the MC terminal to have a television conversation with the MC, to connect with the host terminal to have a television conversation with the host (parents, relatives of the bridal pair), or to break the connection with the hall, respectively.

When an online guest clicks a button for connecting to MC or a button for connecting to host, web server (20) allots a calling screen (not illustrated) to MC terminal or host terminal, respectively. When MC or host clicks an accept button provided on the calling screen, the terminal address of the online guest is registered at the position of Connect To MC or Connect To Host in the Connected Terminal Table of communication server (24) and then a television conversation between the online guest and MC or host can be made. Although an illustration of a displayed screen for a connection to MC or a connect to host is omitted, it is preferable to display image of the calling companion on a popup window maintaining the connection to hall rather than to disconnect with the hall and then display the image of the calling companion in full screen as in conventional videophone.

Further, an END button is provided in the screen when a connection to MC or a connection to host is carried out. By clicking the END button, the terminal address of the concerned online guest is removed from the position of Connect To MC or Connect To Host in the Connected Terminal Table of communication server (24) and then the communication of the concerned online terminal with MC terminal or host terminal is terminated.

When an online guest clicks the button for exiting the hall, the terminal address of the concerned online guest is removed from the position of Connect To Hall in the Connected Terminal Table of communication server (24) and then the communication of the hall terminal with the concerned online terminal is terminated.

Further, by clicking a specific guest on the allotted screen in the online terminal, it is possible to have an individual television conversation between guests. This can be realized by display an allotted screen transmitted by communication server (24) as a clickable map in web page of web server (20). When an online guest appoints and clicks a specific position on the allotted screen, web server (20) finds out a called terminal which lies in the clicked position and then allots a call screen (not illustrated) onto the called terminal. At the called terminal, when a guest clicks an approval button provided on the call screen, the terminal address of the calling side and the terminal address of the called side which have approved the call are registered at the position of Connect with Individuals in the Connected Terminal Table of communication server (24) and then a television conversation between the individual online guests can be made.

In such case, as in said connection to MC or connection to host, it is preferable to display image of the calling companion on a popup window maintaining the connection to hall rather than to disconnect with the hall and then display the image of the calling companion in full screen as in conventional videophone.

Further, an END button is provided in the screen when a connection to individuals is carried out. By clicking the END button, the terminal addresses of the both online guests are removed from the position of Connect with Individual in the Connected Terminal Table of communication server (24) and then the communication between the concerned online terminals is terminated.

Further, by installing an online terminal having a videophone function at each table in the hall, it is possible for a hall guest to call an online guest to have an individual conversation.

In case where an online guest wants to call a hall guest present in the hall, the online guest can appoints and clicks a position of the hall guest on an allotted screen, by which a call screen in which the clicked position has been marked is displayed on a terminal of the corresponding table to the clicked position. Accordingly, it is possible to know who is called from the clicked position marked on the call screen displayed in the terminal of the concerned table. When the hall guest of the called side clicks an approval button provided on the call screen, an individual television conversation between the online guest and the called hall guest can be made.

FIG. 6 shows an example of a screen displayed in the hall display (32). As illustrated in the figure, a screen in which images of each online guest are arranged around tables is displayed and placed so as to be seen well to hall guests. Accordingly, it can give a sensation as if there are tables of each online guest in the hall.

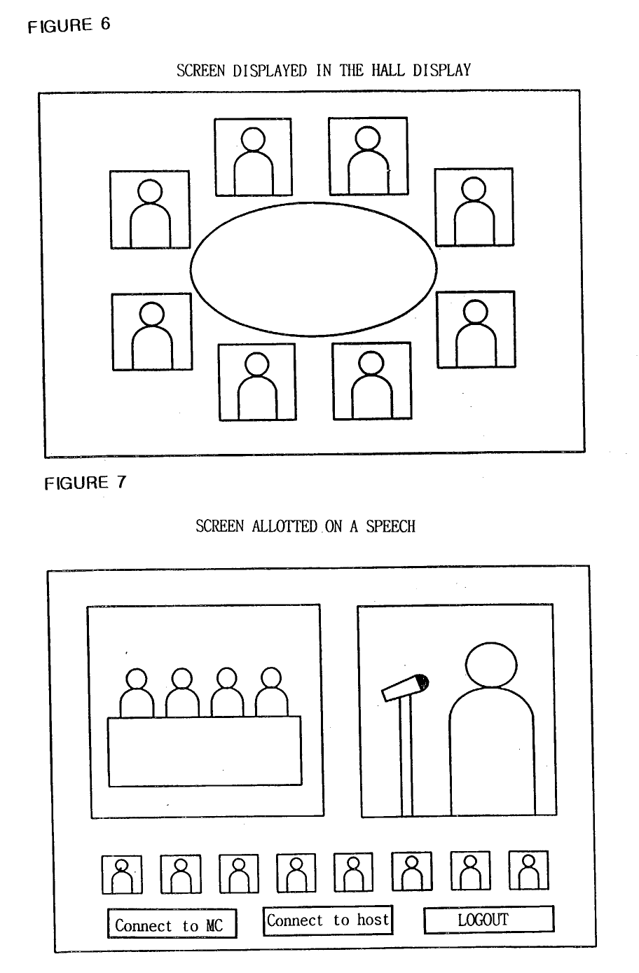

FIG. 7 shows an example of a screen allotted to each online guest when a hall guest does a speech. As illustrated in the figure, the image of the panorama view of the hall is modified and synthesizing image of an orator and image of main table is displayed. As such, since it is possible to compare the orator with a response of the bride pair to the speech, it can give a similar sensation to the case that each online guest really seats at the hall to attend the ceremony.

Although FIG. 7 illustrates a screen in which the images of each online guest is displayed in a small size at the bottom of the screen as in the hall of FIG. 5, images of each online guest are not necessarily contained in the screen, further they may be omitted. Although FIG. 7 illustrates a screen in which the image of an orator is displaced side by side with the image of main table, it is possible to display other image of the hall side by side or to display only the image of an orator. Further, it is possible to maintain the image as in FIG. 5 and then to display image of an orator on a popup window over it.

Although an illustration of an allotted screen onto online guests or the like in case where a online guest does a speech is omitted, it is possible to display the image of an online guest doing a speech side by side with a main table of the hall as in FIG. 7, or it is possible to maintain the image as in FIG. 5 and then to display image of an online guest doing a speech on a popup window over it, for example. Further, although an illustration of a screen displayed on the hall display in case where a online guest does a speech is omitted, it is possible to display only online guests, or it is possible to maintain the image as in FIG. 6 and then to display image of an online guest doing a speech on a popup window over it, for example.

The above matter can be realized by establishing the selective synthesis information (a) of image and sound of online guest or the selective synthesis information (b) of image and sound of the hall on the basis of display style of a screen appointed by a hall manage in hall display (30) as described above.

As described in the above embodiment, communication means (24) is constructed so as to make it possible to change the method of synthesize image and sound by utilizing the selective synthesis information (a) of image and sound of online guest or the selective synthesis information (b) of image and sound of the hall, and thus, it is possible to freely arrange the image allotted onto online guests or the like or the image displayed at the hall display.

Next, when a wedding reception is held and it is possible to attend the wedding reception via online by using an online terminal of the present invention, a flow from issuing of a letter of invitation to opening the reception is explained.

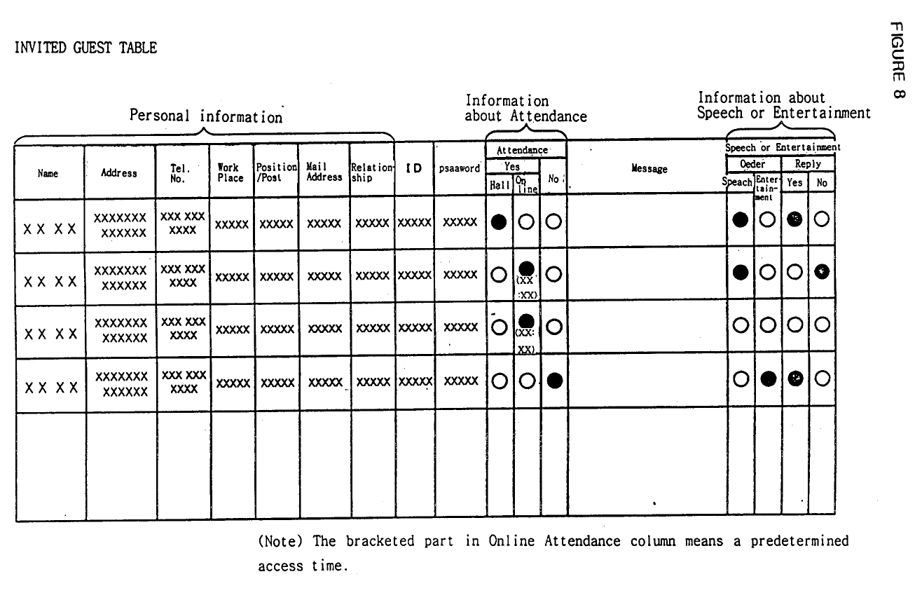

In this embodiment, an invited guest table is prepared at web server (20) as in FIG. 8. At first, a host of a wedding reception (usually including a bride, a bridegroom, representatives of both family, friends, etc.) selects guests to be invited and registers their personal information in the invited guest table. Personal information includes, for example, name, address, telephone number, work place, position/post, mail address, relationship with bridal pair, etc. Further, among the invited guest registered as above, an order mark of a speech or entertainment is added to a guest who will be requested to do a speech or entertainment. Accordingly, a sentence of request for a speech or entertainment is added to a letter of invitation as described below.

When a host accesses from a host terminal (70) to a page for registering invited guests (not illustrated) and inputs personal information of the invited guest, the personal information is registered in an invited guest table to issue a characteristic ID and password to each registered invited guest. Further, the ID may be generated by combining an identification number of the wedding reception with an identification number of the invited guest and the password may be generated by employing random numbers or the like. Further, as to a guest who will be requested to do a speech or entertainment, an order column for designating an order of a speech or entertainment is clicked to mark it.

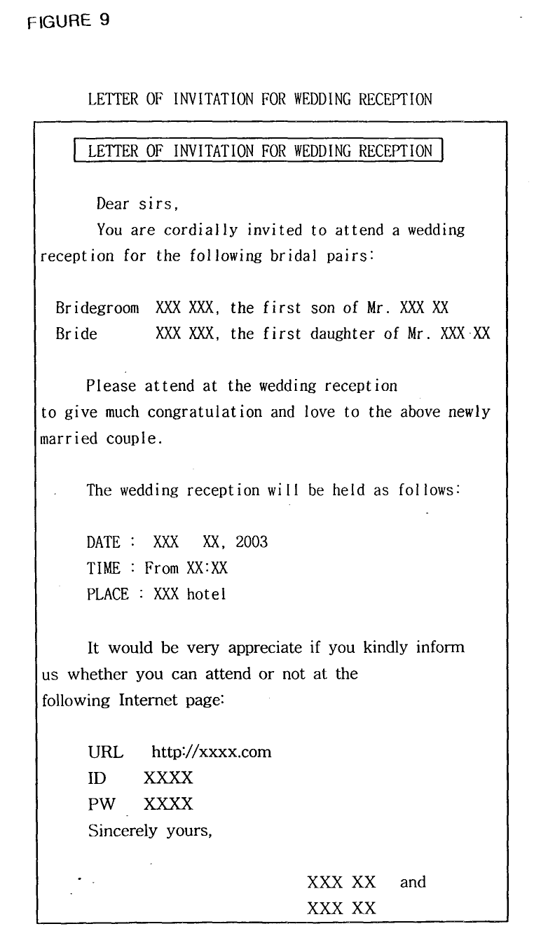

When personal information of an invited guest is registered in an invited guest table, a letter for invitation is issued according to the invited guest table. FIG. 9 illustrates an example of a letter for invitation issued. As in the figure, the letter for invitation describes an invitation writing of a wedding reception and the date and place of the wedding reception, as well as URL of a web page in which an invited guest can reply his attendance or nonattendance and the characteristic ID and password of each invited guest.

Further, although the issuance of a letter for invitation is supposed to automatically issue and send a letter for invitation describing the contents as in FIG. 9 to e-mail address registered in an invited guest table, it is possible to automatically print and send a postal mail to the postal address registered in an invited guest table

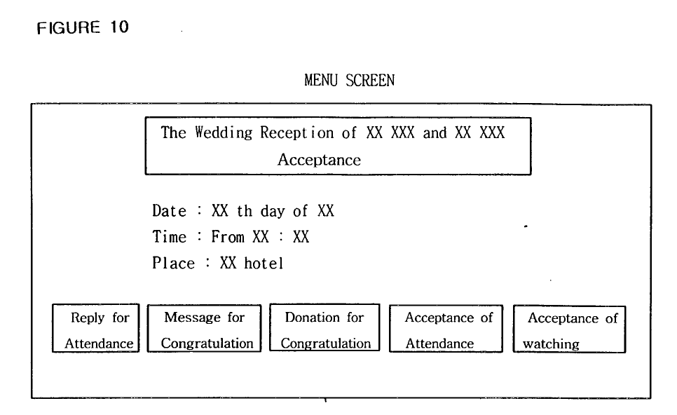

When an invited guest who has received a letter for invitation accesses the URL described in the letter for invitation, a menu screen as illustrated in FIG. 10 is displayed. Menu screen describes the Acceptance to a wedding reception, date and place of a wedding reception and the like and is provided with a button for reply of attendance or nonattendance, a button for accepting a message of congratulation, a button for accepting a donation for congratulation, a button for acceptance of an attendance, a button for acceptance of watching, etc. These buttons can be simply expressed to buttons of Reply, Message, Donation, Attend and Watch, respectively. Further, since the acceptance of attendance and the acceptance of watching are activated after the start of acceptance of the day of the wedding reception, buttons therefor are not shown.

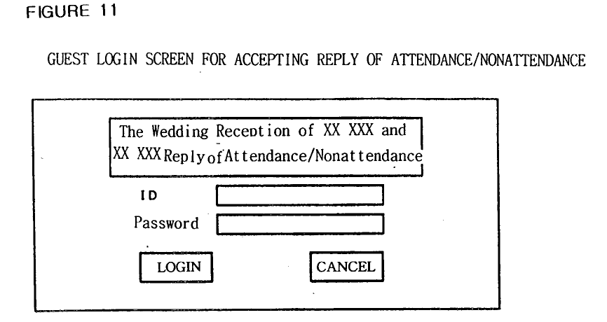

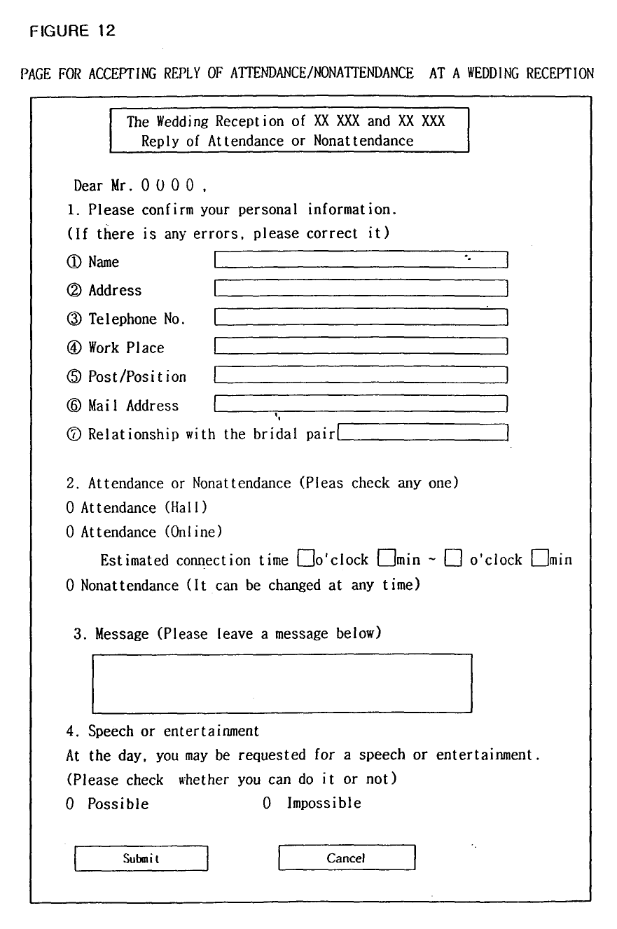

When an invited guest clicks the button for reply for attendance or nonattendance, a screen as in FIG. 11 is displayed. By inputting ID and password described in a letter for invitation, the reply of attendance or nonattendance is accepted.

FIG. 7 shows an example of a page for accepting a reply of attendance at a wedding reception. In the page for accepting a reply of attendance, the personal information is firstly shown to prompt guests to confirm it. Personal information to be shown is extracted from an invited guest table based on the invited guest ID inputted on the login. Accordingly, an invited guest can do a correction only if there is any error in his/her personal information.

Next, it is prompted to input a reply of attendance or nonattendance. As to attendance, an invited guest can select an attendance at the hall and an online attendance which can be made by using an online terminal having a videophone function. In case of an online attendance, the guest is prompted to input an estimated connection time. Accordingly, when an online guest can partially attend a wedding reception, the online guest can notify the schedule to the front desk or MC. Further, even if a nonattendance has been selected, a change to attendance at the hall is difficult, but a change to online attendance is possible at any time as long as the communication server and network can afford it.

Next, it is prompted to enter a message to host. This is supposed to receive a message from an invited guest who replies nonattendance, but it is possible to request all invited guests including invited guests who reply attendance to enter a message. It is possible to record the message as a multimedia message by receiving image and sound or picture from an online terminal having a videophone function, as in an electronic guestbook described below.

Further, as to a letter for invitation sent to an invited guest who is marked in an order column for a speech or entertainment, a message ordering a speech or entertainment at the wedding reception is additionally described, and it is prompted to enter a reply of yes or no to the request.

When a send button is finally clicked, the entered information is returned to web server (20) and then registered in an invited guest table. Such function can be executed by, for example, a CGI program registered at web server.

Further, although the above embodiment is explained to obtain a reply of attendance by using a web page, it is possible to obtain a reply of attendance by mail and then register the reply into an invited guest table.

When the replies are collected in an invited guest table, an accepted guest table is automatically generated, which registers the accepted guests (including both of hall guest and online guest) who have replied to attend the wedding reception both at hall or via online. FIG. 13 illustrates an example of an accepted guest table. Here, since personal information can be confirmed by reference of an invited guest table, it describes only the minimum necessary to MC and front desk such as name, work place, position/post, relationship with bridal pair, etc., but it can be made with the same format with an invited guest table. Further, as to the column of Attendance Type, a mark is entered into any one part of “Hall” attendance and “Online” attendance and a predetermined access time is added in case of “Online” attendance. Further, as to the column of Order of the Speech/Entertainment, a mark is added for an invited guest who has replied to accept the order among invited guests who have been ordered to do a speech or entertainment. Further, the columns of Yes and No of Designation of Speech/Entertainment, Acknowledgement (that is, Selection of Return Present), Food Delivery, Guestbook Data in the accepted guest table are established at the time of the attendance of the guests as described below.

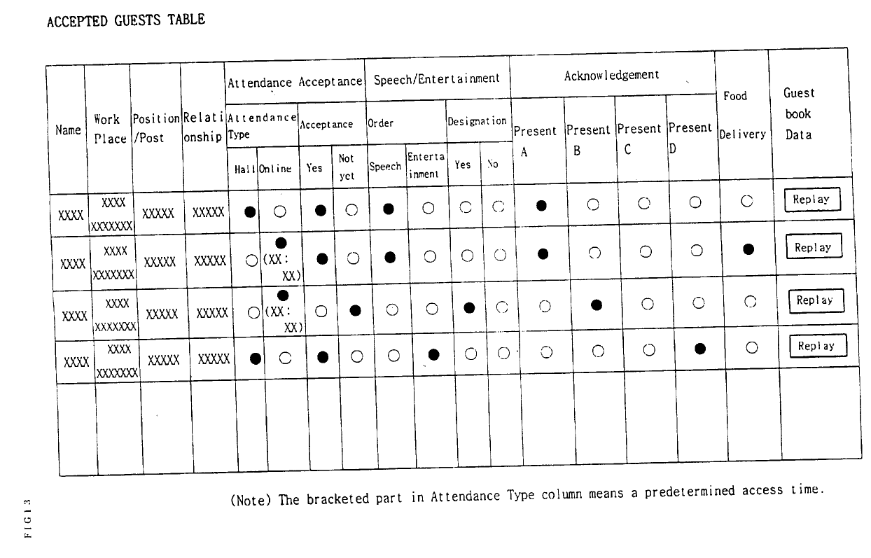

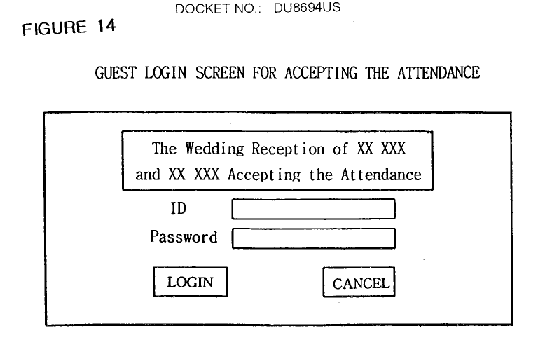

When an acceptance of attendance at the wedding reception starts and a guest who has replied to attend clicks a button of Acceptance of Attendance in a menu screen of FIG. 10, a screen as shown in FIG. 14 is displayed. If a guest ID and password are entered and then login button is clicked as in the reply of attendance, the attendance at a wedding reception starts.

FIG. 15 shows an example of an attendance accepting screen. As can be seen in the figure, personal information is firstly shown to prompt guests to confirm it. Personal information is extracted from an invited guest table based on the invited guest ID as in the case of reply of attendance, and it is prompted to do a correction if there is an error in the description.

Next, it is prompted to enter the selection of a return present that a guest wants. This is to consider that other guest may want other goods or a return present may be the same goods with that of other wedding reception. Pictures of the goods are shown as in the Figure, which can makes it possible for a guest to select a present that the guest wants. Further, if a guest clicks a picture of goods, more detailed information about the goods may be given for reference.

Here, goods to be selected can be changed according to the amount of a donation accepted from the guest. In such case, a return present registering table, in which names of the goods graduated according to the amount, images of the goods, web page for detailed explanation of the goods are registered, is installed, and then, a search is made whether a donation is accepted or not. Then, if a donation has been accepted, appropriate goods are extracted from the return present registering table and displayed as return present in the above screen for accepting the attendance.

Further, as in the staying up all night or an acknowledgement of attending a funeral, only one goods is decided as a return present without considering the donation amount. Therefore, it is better to install a function of classifying and employing according to the purpose.

Next, it is prompted to enter a reply Yes or No about the designation of a speech or entertainment. This is to notify the designation of ordering a speech or entertainment to an attended guest since there may be generated a necessity to directly request a speech or entertainment to a guest other than the guests prearranged to do a speech or entertainment according to the progress state of the reception.

Next, it is prompted for a guest to register for a guestbook. As different from hall guests, online guests cannot put their signature on a guestbook. Therefore, as the alternative, an electronic guestbook is considered in which video, picture, message, etc. are registered.

For example, if the button of Video register is clicked, a video registration screen (not illustrated) is shown, and image and sound of the online guest obtained by camera and microphone of the terminal according to the operation of an online guest are recorded. Further, if the button of Image register is clicked, an image registration screen (not illustrated) is shown, and then an electronic file of an online guest's still picture or an appointed picture obtained by camera of the terminal according to the operation of an online guest is recorded by the operation of the online guest. Further, if the button of Message input is clicked, a text input screen (not illustrated) is shown, and a text message typed by an online guest is recorded. In addition, it is possible to incorporate the same function of editing video or pictures as in the message acceptance as described below.

Such treatment can be executed by installing in advance a customized program in a terminal of an online guest, and the program may be obtained by download when utilizing the services of the present invention. Further, it is possible to construct the system so as to transmit image and sound of a terminal to Web server (20) via Communication server (24) and then to edit and process the received image and sound by CGI at Web server. Otherwise, for example, it is possible to enter a file of image and sound or picture of a terminal into Web server (20) via Communication server (24) by employing a conference function in accordance with Standard T.120 of ITU-T and then edit and process it.

Next, online guests are asked whether to want an express delivery of food or not. In general, in a ceremonial occasion such as wedding and funeral, foods are prepared in the hall of the ceremony and hall guests dine together and have a pleasant conversation. However, since online guests watch only an allotted screen before a terminal, it is difficult to pace with hall guests.

Therefore, it is constructed so as to accept an application for the services to deliver foods to online guests who have wanted a delivery service of food according to the start time of a wedding reception.

Food delivery services to an online guest are limitedly applied only to a person who has registered a donation more than a certain amount. In such case, the above inquiry whether to want food delivery services is exhibited in the above attendance accepting screen in case where the donation is more than a predetermined amount after searching the donation of an online guest and the donation amount from a donation registering table.

Further, although the inquiry whether to want food delivery services is exhibited on the acceptance of attendance in the embodiment, it is possible to exhibit the inquiry when doing a reply of attendance since some foods may need a previous order. Further, in case where food delivery services are limitedly applied only to a person who has registered a donation more than a certain amount, it is possible to exhibit the inquiry when a donation of more than certain amount is accepted.

Lastly, when a button of transit is clicked, the entered information is registered in an accepted guest table. If there is a correction in the personal information of the accepted guest, the accepted guest table as well as the invited guest table are corrected. Further, the information about the reply of designation for a speech or entertainment or a return information is marked in the corresponding column in the accepted guest table as described in FIG. 13.

Further, the electronic guestbook data is attached to the accepted guest table as a link data. Therefore, by clicking a replay button at the guestbook data column, the replay method is selected and then the recorded data is replayed.

During accepting an attendance, an order for food delivery is issued to a food delivery businessman when there is a desire of the food delivery. For sake's of the above, there is provided with which registers a services area of food delivery businessmen and mail address. If an online guest desires food delivery services, a food delivery businessman is selected by reference of a table of registering food delivery businessmen and an order for food delivery which describes the address of the online guest, start time of the wedding reception and the contents of food is sent via mail.

The services area of food delivery businessmen may register the postal code capable of doing the services or the boundary on a map capable of doing the services to calculate the position on the map from the address of an online guest to select a food delivery businessman.

Further, the food delivered to an online guest may be a fixed menu which has been specified in advance to the food delivery businessman, and thus the contents of food ca be omitted from an order sheet. Otherwise, food may be selected among multiple kinds by an online guest when the online guest is accepted for attendance, and then the result may be described on an order sheet. Further, after searching the existence of a donation of an online guest and the amount of the donation, the food may be selected from multiple foods according to the registered amount of donation and then the selected menu may be described in an order sheet.

Acceptance of the attendance at the wedding reception is supposed to be done at an online guest terminal for online guests and at a front desk terminal placed in the hall for a hall guest. Therefore, the acceptance of attending at the hall can be manless, in which a hall guest may operate a manless terminal for accepting the attendance. In such case, since there may be guests who cannot well operate a personal computer or the like, it is preferable to arrange a person in charge for acceptance at the front desk or any place to operate the terminal instead of the persons who cannot operate a personal computer or the like.

As such, by arrange a person in charge for acceptance or information man at the front desk, an online guest can call a front desk terminal to have a television conversation with an information man, and thus, it is possible to check the state of attendance at the hall or forward an urgent matter. Further, when an online guest wants to have a conversation with a hall guest, the online guest can request an information man to call a hall guest and then to have a conversation with a hall guest by using the front desk terminal.

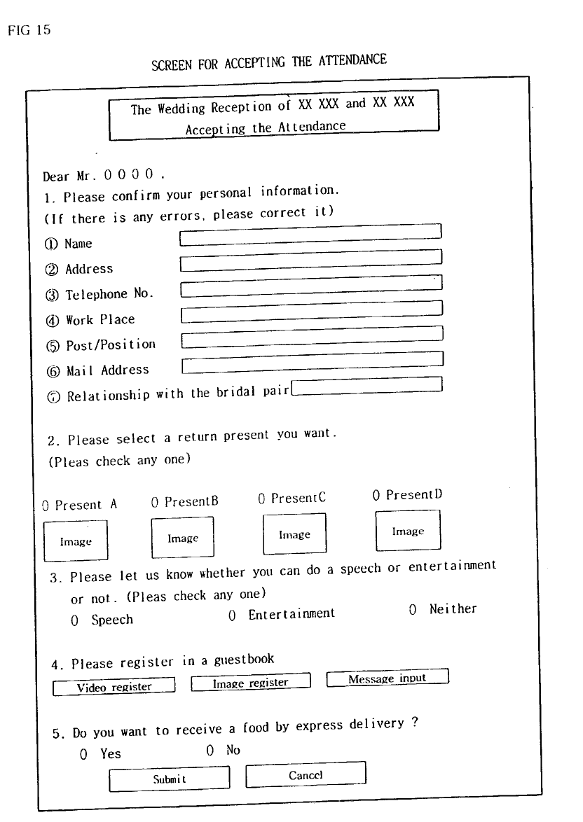

FIG. 16 illustrates an example of a screen after completing the acceptance of the attendance. As in the Figure, the acceptance of the attendance is posted and the attendance is invited.

In the screen after completing the acceptance of the attendance, the present attended guests are displayed by dividing into hall guests and online guests. For each guest a call button is assigned. When an online guest clicks a call button for calling other online guest, a called screen (not illustrated) is displayed in an online terminal of called guest by Web server (20). When the called online guest clicks an approval button provided in the called screen, the terminal address of an online guest of the calling side and the terminal address of an online guest of the called side are registered in a connected terminal table of Communication server (24), by which a television conversation between the online guest can be made. Further, when an online guest clicks a call button of a hall guest, a called screen (not illustrated) is displayed in a front desk terminal via Web server (20). When the called hall guest come to the front desk terminal to be capable of having a conversation, an approval button is clicked and thus the terminal address of an online guest of the calling side is registered at the Connect to Front Desk in a connected terminal table of Communication server (24), by which a television conversation between the online guest and the hall guest called to the front desk terminal can be made.

In the screen after completing the acceptance of the attendance, a button of Connect to front desk, a button of Connect to MC and a button of Connect to host are provided. When an online guest clicks these buttons, as explained as above, the terminal of the online guest is connected with the front desk terminal, MC terminal and host terminal, respectively, to make it possible to have a television conversation with an information man, MC and a host, respectively.

In the screen after completing the acceptance of the attendance, a button of Enter into waiting room is provided. When an online guest clicks this button, the terminal address of the online guest is registered at Connect to waiting room in a connected terminal table of Communication server (24), by which a television conversation between a hall guest at the waiting room and the online guest who ahs already connected to waiting room can be made.

Further, in the screen after completing the acceptance of the attendance, a button of Enter into hall is provided. When an online guest clicks this button, the terminal address of the online guest is registered at Connect to hall in a connected terminal table of Communication server (24), by which the online guest can attend the waiting room via online. This button of Enter into hall is not displayed before the opening.

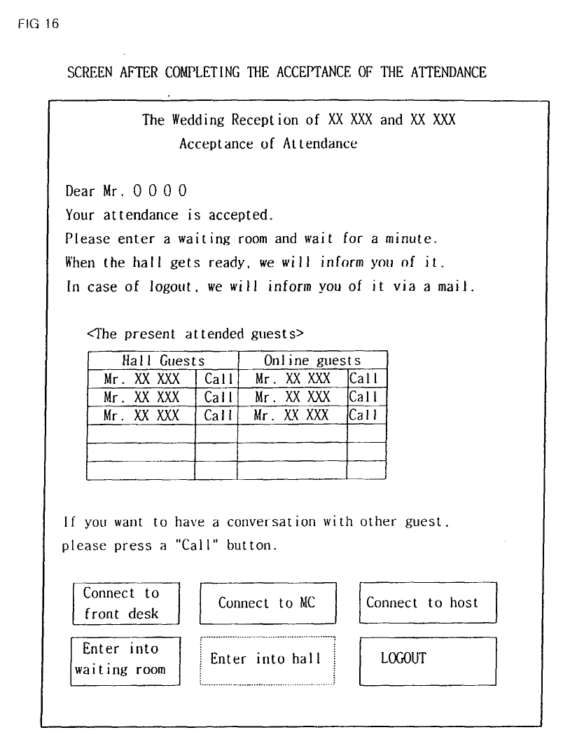

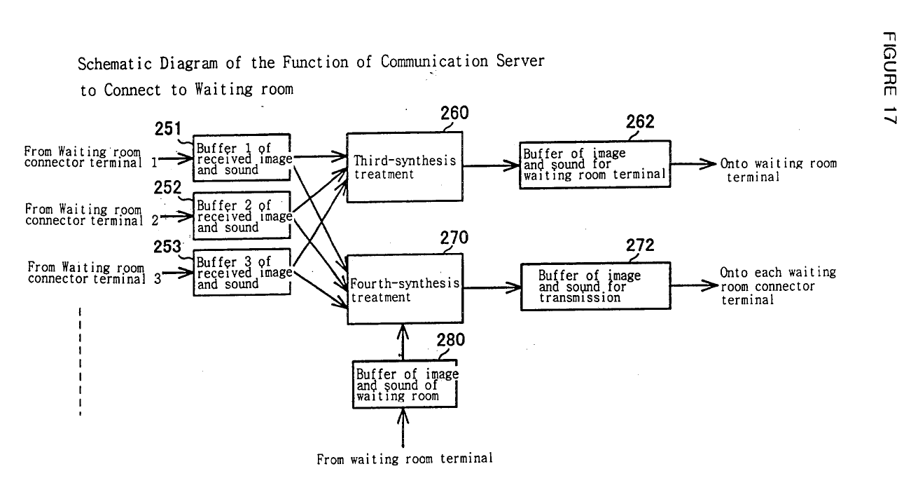

FIG. 17 illustrates a schematic diagram of the function of communication server to connect to waiting room.

As in the Figure, the image and sound transmitted from terminals of each waiting room connector is streamingly received to be sequentially stored in buffers (251), (252), (253), . . . of received image and sound, respectively. The image and sound stored in buffers (251), (252), (253), . . . of received image and sound are sequentially synthesized at a third-synthesis treatment (260), the synthesized image and sound are sequentially stored in a buffer (262) of image and sound for waiting room terminal. The image and sound stored in the buffer (262) of image and sound for waiting room terminal are sequentially read and transmitted onto a waiting room terminal (60).

Further, the image and sound transmitted from a waiting room terminal are streamingly received and then stored in a buffer (280) of image and sound for waiting room. The image and sound stored in the buffer (280) of image and sound for waiting room are sequentially synthesized with the image and sound stored in the buffers (201), (202), (203), . . . of received image and sound at a fourth-synthesis treatment (270), the synthesized image and sound are sequentially stored in a buffer (272) of image and sound for transmission. The image and sound stored in the buffer (272) of image and sound for transmission are sequentially read and transmitted onto each waiting room connector terminal.

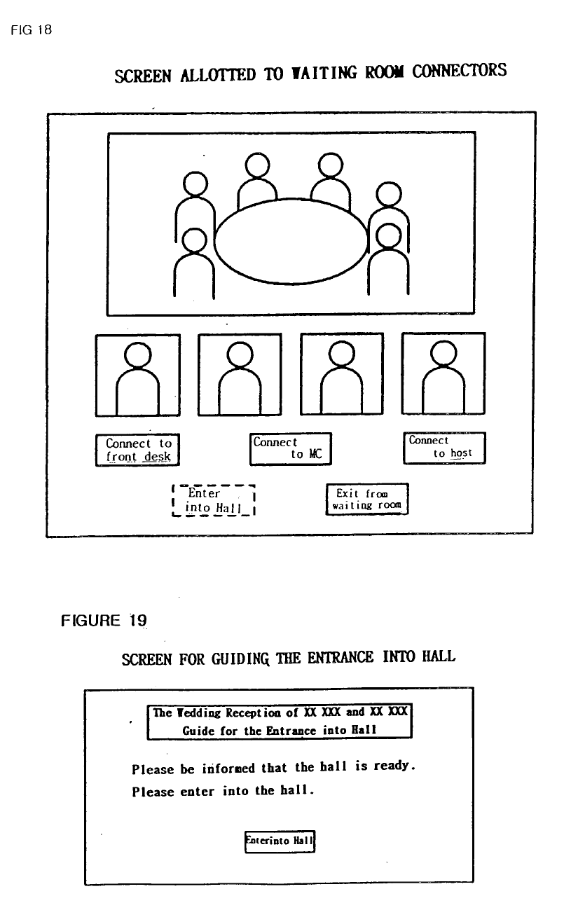

FIG. 18 illustrates an example of allotted screen by a function of connecting to waiting room. As in the Figure, the image of waiting room is displayed in the upper part of the screen, and the images of each waiting room connector are displayed side by side in the lower part of the screen. Meanwhile, although a screen displayed in the waiting room terminal is not illustrated, the images of each waiting room connector are displayed side by side.

In the above third-synthesis treatment or fourth-synthesis treatment, the image and sound of each waiting room are synthesized under a certain condition without providing any means of inputting selective synthesis information. However, it is possible to change the synthesis method according to information from outside or to be provided with a function of changing the display style, as in the above first-synthesis treatment or second-synthesis treatment. It may have a function of, for example, enlarging image of a special waiting room connector by an operation at the waiting room, enlarging of image of a person who is now sending sound signal by detecting the levels of voices transmitted from each waiting room connect, or changing the color of screen.

In a screen of waiting room connectors, a button of Connect to front desk, a button of Connect to MC and a button of Connect to host are provided by Web server (20). When a waiting room connector clicks these buttons, as described in the above, it is possible to connect with the front desk terminal, MC terminal and host terminal, respectively, and to have a television conversation with an information man, MC and a host, respectively.

In a screen of waiting room connectors, a button of Exit from waiting room is provided. When a waiting room connector clicks this button, the terminal address of the online guest is removed from Connect to waiting room in a connected terminal table of Communication server (24), by which the online guest can exit from the waiting room.

Further, when the hall is ready, a button of Enter into hall is then shown in a screen of waiting room connectors. When a waiting room connector clicks this button, the terminal address of the online guest is removed from Connect to waiting room and then registered at Connect to hall in a connected terminal table of Communication server (24). Accordingly, the online guest can exit from the waiting room and then enter into the hall.

When the hall is ready, it is notified all online guests under login with a popup window that the hall is ready and entrance into the hall is possible. This, for example, can be done when a hall manager at hall terminal (30) requests web server (20) to display a screen for guiding the entrance into hall as in FIG. 19 at the terminal of each online guest under login. In the screen for guiding the entrance into hall, a button of Enter into Hall is provided. When an online guest under login clicks this button, the terminal address of the online guest is registered at Connect to hall in a connected terminal table of Communication server (24). Accordingly, the connection with the hall terminal is established.

Further, when an online guest who has completed the acceptance of attendance does logout, it records it and sends the online guest a guide for the entrance into hall via mail of HTML format to prompt the entrance into hall.

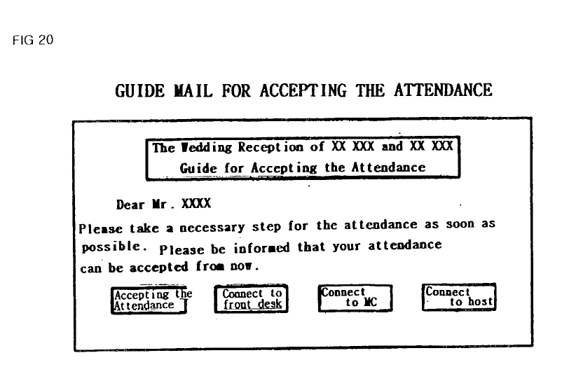

In the above embodiment, when the acceptance of the wedding reception is started, it is explained that each guest by himself enters the guest ID and password to accept his attendance. In such case, it is possible to send a guide mail for accepting the attendance as illustrated in FIG. 20 which prompts to accept the attendance and then to accept the attendance of the online guest when the online guest replies to the mail. As such, online guests can know that the accepting of the attendance is started by receiving a guide mail for accepting the attendance. Further, in a guide mail for accepting the attendance, a button of Accepting the Attendance is provided. When an online guest clicks this button, the online guest can complete an acceptance without login operation. Further, in a guide mail for accepting the attendance, a button of Connect to front desk, a button of Connect to MC and a button of Connect to host are provided. When an online guest clicks these buttons, it is possible to connect his/her online terminal with the front desk terminal, MC terminal and host terminal, respectively, without any login operation and to have a television conversation. Such mail provided with a button of Accepting the Attendance or various connect buttons can be realized by using a mail of HTML format.

Next, the progress of a wedding reception by a MC is explained.

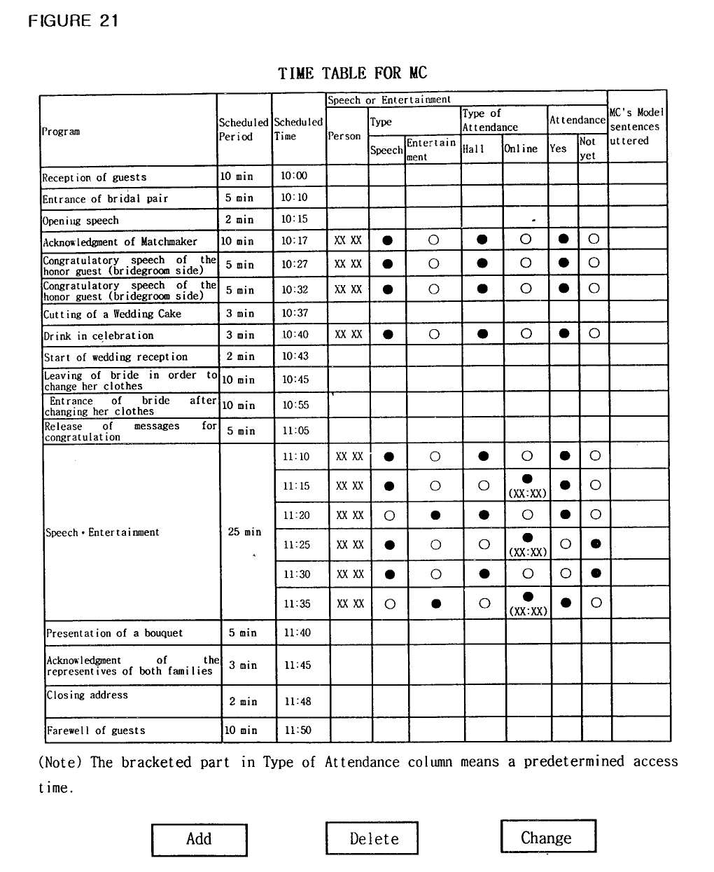

FIG. 21 illustrate an example of a time table displayed in MC terminal. As in the Figure, the time table describes the scheduled period and time of programs. MC (Master of ceremonies) can confirm it at MC terminal to progress the wedding reception, by which time control can be made exactly.

Further, in the time table, the name of persons ordered for a speech or entertainment, order type (Speech or Entertainment), attendance type (Hall Attendance or Online Attendance), attendance state are described in a table. Further, since there is a partial attendance as to an online guest, a predetermined access time is additionally described for the Online attendance of the attendance type. Therefore, MC can easily catch the state whether a guest requested for a speech or entertainment is present or not or has accessed or not, and then find a substitute or change the order of the program, by which it is possible to plan an exact progress of the program.

In addition, in the time table for MC, since model sentences uttered by MC are displayed according to the progress of each program, by simply uttering the sentences, the MC can progress the ceremony without stuck for a word even if the MC is a beginner or has a short career.

Further, since the above time table for MC is provided with buttons for Add, Delete and Change so as to edit the time table at MC terminal, any miss such as omission or repetition of introduction can be prevented by amending any changes or errors caused by, for example, change of schedule of guests.

In the MC time table, since said accepted guest table can be called and displayed, MC can refer to the guest's profile and reflects it to the progress of a ceremony.

Further, since the accepted guest table contains the reply of Yes or No to the designation of a speech or entertainment of each guest, MC can cope with the situation when a guest prearranged to do a speech or entertainment is suddenly absence, or can appoint a suitable speech or entertainment when there remains some time.

Next, a function of recording a commemorative photograph is described. During the wedding reception, since the images of hall guests can be captured by television camera of each online terminal, it is possible to gather all persons attending a wedding reception in a spot to take a commemorative photograph. For example, a hall manager or MC heads up to gather and stand up all attended persons around the bridal pair before any one camera in the hall, and then makes all the persons face the camera and operates a hall terminal to capture the allotted images, from which a still picture is selected and recorded. It is possible to capture frame images from the record of the allotted images in communication server (24) and then to transmit and record them to Web server (20) as commemorative photographs, or it is possible to receive the allotted image at Web server (20) and then to directly capture frame images to record them as commemorative photographs. The obtained commemorative photograph may be attached to the above accepted guest table or to a wedding reception registering table. As such, according to the system for providing ceremonial occasion services of the present invention, it is possible to obtain an image in which hall guests and online guests who are spatially in distance are gathered in a spot.

Since the function of recording a commemorative photograph records as still picture a frame picture of the allotted image allotted onto each online terminal, it is not necessarily the picture of all the attendance. It is possible to cut a frame picture of an optional instance among the allotted image during the wedding reception and then to record it as a commemorative photograph.

Further, it is possible to have a function of cutting, by an operation of a hall manage, an MC, a host, etc, a frame picture of an optional instance among the image of the hall obtained by a hall camera or the images of each online guest transmitted from each online terminal to record it as a commemorative photograph. Accordingly, since it is possible to cut a frame picture of an optional instance among an individual image of a hall guest or individual images of each online guest during the wedding reception to record it as a commemorative photograph, it is possible to remain various scenes of the wedding reception as commemorative photographs without importing any special photographing device.

Next, a function of recording and allotting a video album is described. The system for providing ceremonial occasion services of the present invention has a function of automatically recording the image and sound allotted to each online terminal at communication server (24), transmitting them to Web server (20) after the ceremony, and storing and preserving them as video album. Web server (20) is provided with a wedding reception registering table in which all the wedding reception provided in the system for providing ceremonial occasion services of the present invention are registers with regard to a title such as name of the bridal pair, the date of the reception and the site of the reception and then attached the above stored and preserved video album as a link data. Accordingly, since it is possible to draw out a stored and preserved video album by searching a wedding reception registering table, it is possible to receive it via on-demand and then to read it by using a terminal having a replaying function.

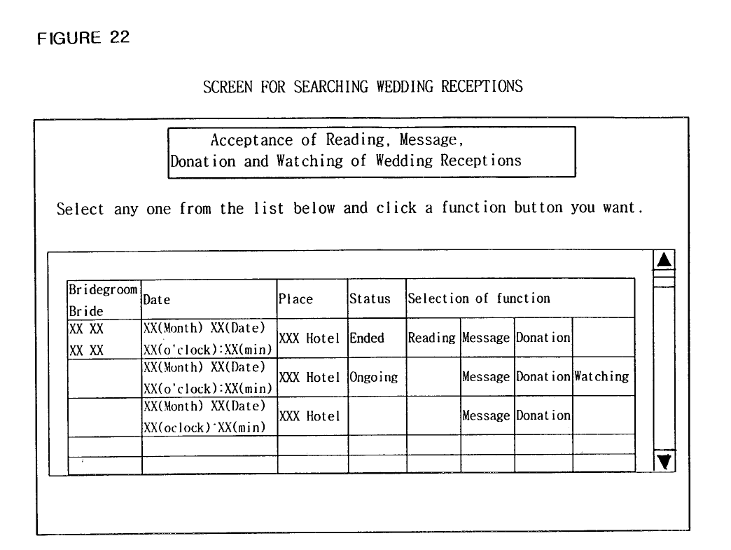

FIG. 22 illustrates an example of a screen for searching a wedding reception to be objected and then accepting a reading, a message of congratulation, a donation for congratulation and a watching. As in the figure, a list of wedding reception registered in the above wedding reception registering table is displayed, and a Reading button, a Message button, a Donation button and a Watching button are provided in the column of Selection of function of each wedding reception. Accordingly, by searching an wedding reception to be objected in the web page and then clicking a button for a reading, a message of congratulation, a donation for congratulation and a watching in the section of function, it is possible to read a video album of the designated wedding reception, to send a message of congratulation to the designated wedding reception, to apply to a donation for congratulation for the designated wedding reception, and to watch the designated wedding reception, respectively. Further, a Reading button is displayed only if a wedding reception has been already terminated, a video album has been registered and the host agreed to open the video album to public. A Message button and a Donation button is displayed when the host is now accepting them and only during the acceptance period. A Watching button is displayed when the wedding reception is now meeting and only if the host agreed to open it to public.

When a Reading button is clicked at the screen for searching wedding receptions, the video album of the wedding reception stored in Web server (20) is transmitted by on-demand and then replayed by animation replay software in the terminal. Accordingly, it is possible to read at any time a wedding reception itself at the day of the wedding reception in a terminal connected to Internet. Therefore, the host or the concerned can utilize the video album as a commemorative data of the wedding reception. Further, a person who is to utilize the services of the present invention can read it for reference, and the concerned businessman of such services can utilize it as an advertisement material. The concerned businessman may select a wedding reception which look betters to open to public or to broadcast via online. In such case, an advertisement rate should be paid to the host of the ceremony or compensation can be made by discount the cost for using the services.

As such, by make it possible for other persons to read a visitor, it is possible for the host to receive messages of congratulation or condolence and to collect donations for congratulation or condolence from more persons. Further, it is possible for a person who is short of funds to make money by using this services and then to have an economic wedding reception.

Next, it is described about accepting a message of congratulation.

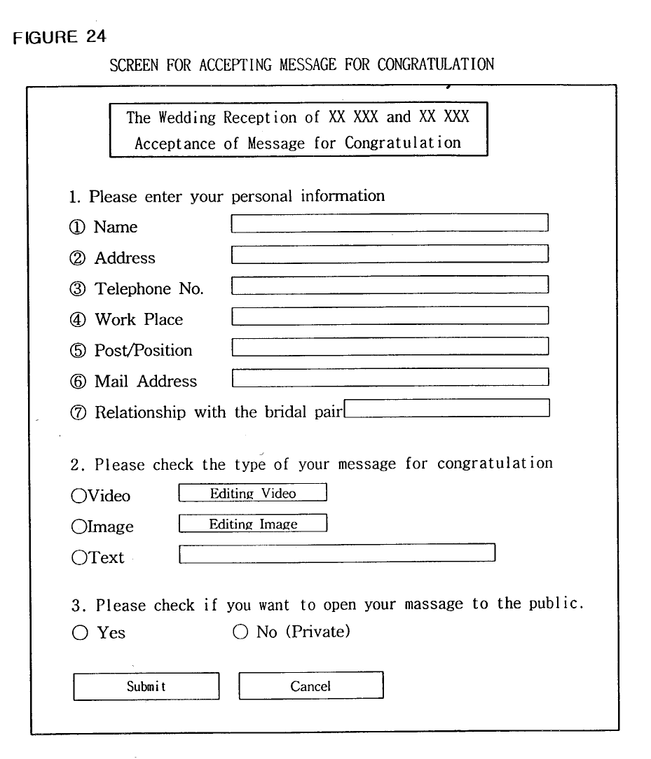

When a Message button is clicked at the screen for searching wedding receptions, a screen as in FIG. 24 is displayed. In the screen for accepting message for congratulation, firstly, it is prompted to enter personal information of the person who send a message, then prompted to select type of message, and lastly prompted to designate about opening the message to the public.

Type of messages is, at the context of the present invention, supposed to 3 types such as a video message, image message (or picture message), and text message. Video message means a message made with mage and sound, and an animation file prepared in advance can be transmitted. In the embodiment, it is supposed to record an animation file by using a terminal having a videophone function, and then to video-edit and send it. Image message means a message with still pictures, and a still picture prepared in advance in a terminal can be transmitted. In the embodiment, it is supposed to obtain a picture of a person who send the message by using a terminal having a videophone function and then to do an additional image-editing such as attachment of image file, addition of caption by using Telop, addition of voice, etc., and finally to send it. Test message means a message only with text or character, and it can be prepared by entering passages directly into a text column as shown in FIG. 24.

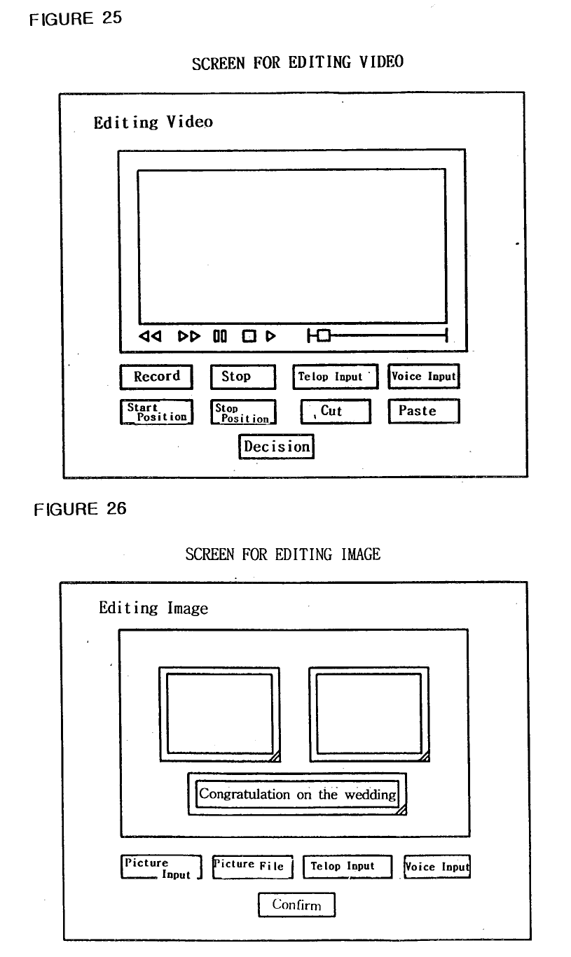

FIG. 25 illustrates an example of a screen for editing video. As in the figure, a video editing framework for editing animation is placed in the middle, in which replay, stop, pause, fast rewind, rewind of the edited animation are made, as well as record and replay can be made by appointing an optional position with a slider bar. At first, by using a record button and a stop button, an animated message is entered at a terminal having videophone function. Next, during replaying it within the video editing framework, a range is decided with Start Position button and Stop Position button and an edition is made with Cut button and End button. Further, captions are entered with Caption Input button, voice messages are recorded with Voice Input button, and attachment is made with Paste button. If the edition is completed, clicking Decision button will lead to the original screen for accepting message for congratulation.

FIG. 26 illustrates an example of a screen for editing image. As in the figure, an image editing framework for editing picture is placed in the middle, in which a still picture is imported by using Picture Input button from a terminal having a videophone function. Further, an attachment of a still picture can be made with Picture File button, captions can be entered with Caption Input button, and voice messages can be recorded with Voice Input button. If the edition is completed, clicking the Decision (or Confirm) button will lead to the original screen for accepting message for congratulation.

Such treatment can be executed, as in the above electronic guestbook, by installing an exclusive program in advance in the online terminal, said program may be downloaded when utilizing the services of the present invention. Further, it is possible to construct the system so as to transmit image and sound of a terminal to Web server (20) via Communication server (24) and then to edit and process the received image and sound by CGI at Web server. Otherwise, for example, it is possible to enter a file of image and sound or picture file of a terminal into Web server (20) via Communication server (24) by employing a data conference function in accordance with Standard T.120 of ITU-T and then edit and process it.

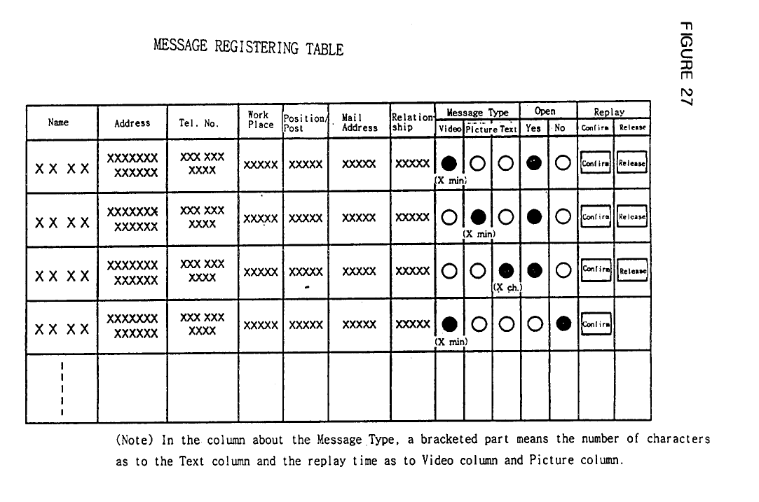

When all the information input is ended, by clicking Submit (or Sending) button, the prepared message for congratulation is registered in a message registering table. FIG. 27 illustrates an example of a message registering table. As in the figure, in the message registering table is registered personal information such as name, address, telephone No, work place, position/post, mail address, relationship with bridal pair, etc., and message type (video, picture, text), open state (Yes, No), and the like.

At the column of Replay of the message registering table, Confirm button and Release button are provided. When Confirm button is clicked, the message is replayed in the terminal screen. Further, When Release button is clicked, the message is displayed in Hall display (32) as well as allotted onto each online guest terminal and each online visitor terminal.

Further, to the message marked as No at the Open column, Release button is not marked. This function is supposed that MC exhibits the messages for congratulation at the wedding reception, MC can easily sort the message to be exhibited by displaying the message registering table onto the MC terminal. Further, since the replay time in case where the message type is video or picture and the number of character in case of the message type is text are displayed together with the mark for the message type, it is possible to sort the messages for congratulation with considering the time needed to exhibit the messages. Therefore, it is possible for an MC to manager the time for the progress of a wedding reception.

A releasing function from a message registering table onto hall and each online terminal can be executed, for example, by registering an MC terminal at the Connect to hall in the connected terminal table of Communication server (24), transmitting the replayed image and sound to the communication server when a Release button in the message registering table is clicked, and synthesizing it as image and sound of an orator in the first-synthesis treatment or second-synthesis treatment.

Further, in order to release from a message registering table onto hall and each online terminal, it may be possible to have a function of receiving the message replayed in the MC terminal to transmit to a hall terminal or to allot onto each online terminal.

In the above embodiment, a message registering table registers only the message which is received via said Web page. If messages for congratulation received by other means can be allowed to be registered in a message registering table, MC can cope with the exhibition of all messages for congratulation only by referencing the message registering table. For example, a message for congratulation via an e-mail can be simply registered as a text message.

Further, in the above embodiment, it is explained that an MC sorts messages to be exhibited in the message registering table, it may be possible to automatically sort messages marked as Yes to Open during a speech to be released. Accordingly, the burden of an MC can be further reduced.

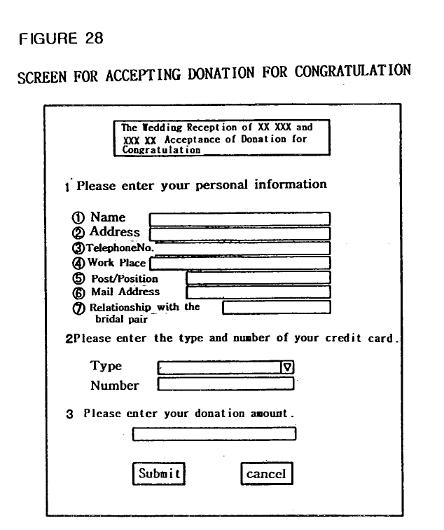

Next, an acceptance of donation for congratulation is described. When a Donation button is clicked in a screen for searching wedding receptions, a screen for accepting donation for congratulation as in FIG. 28 is displayed. In the screen for accepting donation, it is prompted to enter personal information of the applicant of the donation, it is prompted to enter the kind and number of a credit card, and finally it is prompted to enter an amount of donation.

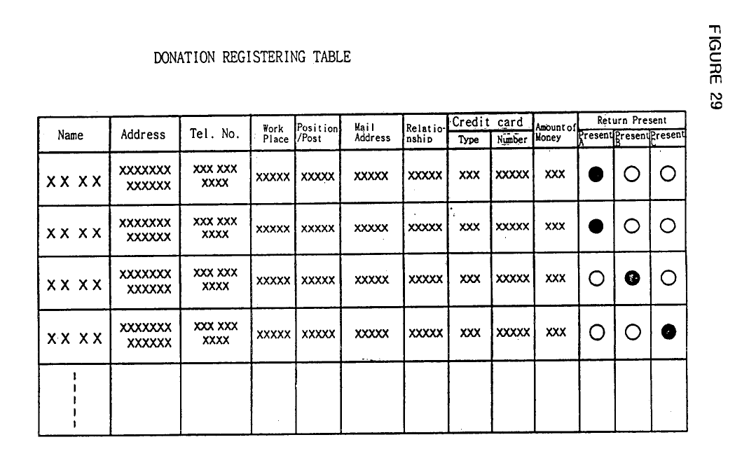

When all the information input is ended, by clicking Submit (or Sending) button, a banking business in a banking organ connected via online is done based on the inputted kind and number of the credit card. When the registered amount of money is paid or payable, the inputted information is registered in the donation registering table. FIG. 29 illustrates an example of a donation registering table. As in the figure, in the donation registering table is registered personal information such as name, address, telephone No, work place, position/post, mail address, relationship with bridal pair, etc., kind and type of credit card and the amount of donation.

In addition, when a donation is accepted, a donation refusal table which registers persons whose donation accepting is refused can be prepared, which has a function of refusing the acceptance of the donation from persons registered therein. This is to record personal information of persons whose donation accepting is refused, to compare the above personal information with personal information of an applicant transmitted from said donation registering table, and when the information data are the same, to return a message that the acceptance of donation is declined.

Accordingly, in case where an acceptance of donations from special persons are not wanted since the host side has a special situation, an application to donation can be automatically refused.

Further, personal information of a person whose donation accepting is refused includes name, address, work place, etc., which are registered in a donation refusal table, but the address or work place may be not entered or can be changed. Therefore, if the names are the same, it should be determined whether the donation is refused or not after confirming the host.

In the system for providing ceremonial occasion services of the present invention, it has a function of selecting a return present according to the amount of donation. For this purpose, the donations are ranked according to their amount, and a return present selecting table is provided, in which the goods selected according to the ranks are registered in advance. Therefore, if the amount of a donation is registered in a donation registering table, a return present is selected by reference of a return present selecting table and then the selected return present is registered in the donation registering table.

In such case, it is possible to prepare a return rate table for establishing a return rate to the donation amount and a return present registering table in which return presents are graduated and registered according to the amount, to calculate the amount to be returned from the donation amount registered in the donation registering table based on the return rate established in the return rate table, and to select a return present from the calculated amount by reference of the return present registering table. Accordingly, by establishing in advance a return rate to the donation for congratulation or condolence, an appropriate return present corresponding to the accepted donation amount will be automatically selected.

Further, as to the table for registering a return present, it is possible to utilize an internet site in which a return present of offered food can be selected within a predetermined cost.

Based on the donation registering table thus registered, the designated amount of money is automatically withdrawn from the bank accounts of each credit card. Accordingly, donations for congratulation can be surely collected from persons who have accepted the donation without giving any embarrassment to the host side.

Further, based on the donation registering table, a delivery order of the selected return present in which the name and address to be delivered to are described is automatically sent to a designated delivery businessman. Then, based on the above delivery order, a predetermined return present is delivered to the person providing a donation who has registered in the donation registering table. Accordingly, without giving any difficulty to the host side, return presents can be delivered to persons who have provided the donation without omission.

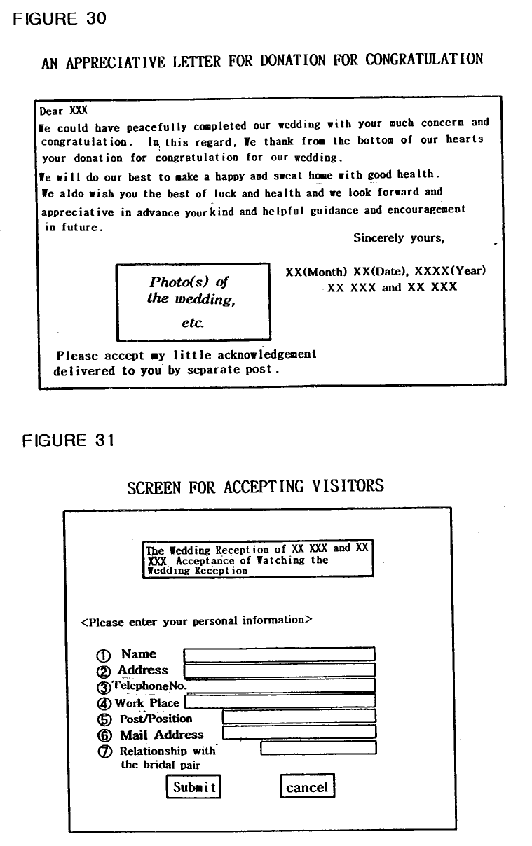

Further, based on personal information described in a donation registering table, an appreciative letter as in FIG. 30 is automatically delivered. To the appreciative letter, pictures recorded by the above described function of recording a commemorative photograph may be attached. Otherwise, by attaching as link data an address code combining an URL of a web page in which the above described video album can be downloaded with a search code with which the wedding reception can be searched, it is possible to download the video album from the web page to replay on the screen. The appreciative letter is prepared in a HTML format. Therefore, when the attached file is a picture, the mail will be a letter with picture, and when the attached file is a dynamic image, the dynamic image can be replayed on the screen by clicking the dynamic image part of the letter.

Further, it is possible to pay the expenses of the wedding reception from the donations which has been automatically collected based on a donation registering table. For example, a center bank is prepared on the network to find the total of the payments for each host of the wedding receptions. Then the expenses of a wedding reception is directly paid from the center bank. Accordingly, since it is possible to unitarily manage the income and expenditure based on the donation as the financial resources, a sound budget management can be made.

Further, when selecting goods as a return present, it is possible to extract the expenses from the total donation amount to obtain the remained donation amount, and then to select goods according to an amount obtained by proportionally dividing the remained donation amount with the amount of a donation. Accordingly, it is possible to balance the income and expenditure of the wedding reception and an economic ceremonial occasion can be made.

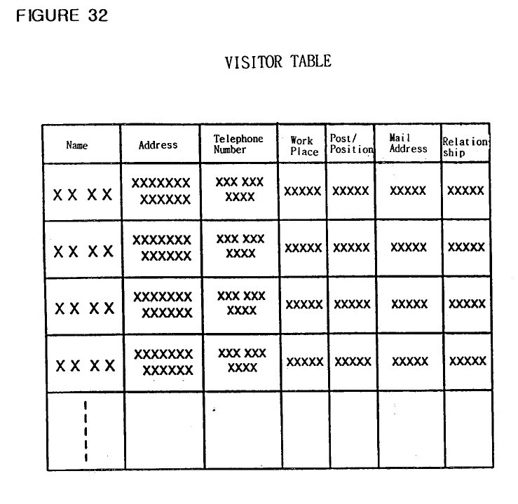

Next, it is described about acceptance of watching a wedding reception. By clicking the Watching button for accepting the watching, a screen as in FIG. 31. In the figure, when personal information is entered and then sent by a person, the person is registered in a visitor table as in FIG. 32, and thus the address of the online terminal which has accepted the watching is registered as an online visitor at the column of Connect to Hall in the connected terminal table of communication server (24). Accordingly, as described above, to teach online visitor terminal the same image and sound with those allotted to each online guest terminal are allotted.

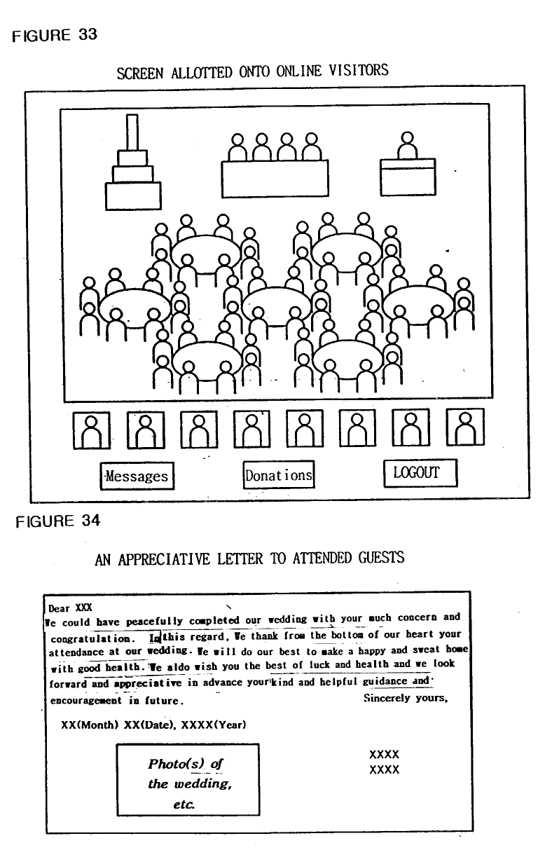

FIG. 33 illustrates an example of a screen allotted onto online visitors. In the lower part of the screen for online visitors, there is given a Message button for accepting a message of congratulation, a Donation button for accepting a donation for congratulation, and a Logout button. If the Message button is clicked by each online visitor, a treatment of accepting the message as described above is carried out. If the Donation button is clicked, a treatment of accepting the donation as described above is carried out. If the Logout button is clicked, the address of the online visitor terminal is removed at the column of Connect to hall in the connected terminal table of communication server (24), and thereby, the online visitor can terminate the watching.

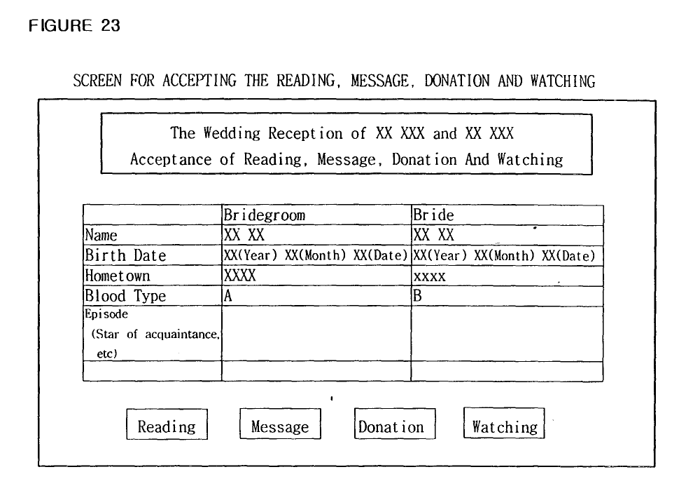

In the above embodiment, it is explained that the column of Selection of function is provided in the screen for searching wedding receptions, and a button provided in the column of Selection of function is clicked to accept the reading, message of congratulation, donation for congratulation, and watching of the wedding reception selected. However, when in the screen for searching wedding receptions a wedding reception to be objected is selected, it is possible to display the screen for accepting the reading, message, donation and watching as in FIG. 23 which describes the outline of the selected wedding reception. By clicking a Reading button, a Message button, a Donation button and a Watching button, it is possible to make an acceptance of the reading, message, donation and watching, respectively.

In the above embodiment, it is explained that the allotted image and sound are recorded in communication server (24), transmitted to Web server after the wedding reception and stored and preserved as video album, but it is possible to store and preserve them as video album in communication server and then to transmit the stored and preserved data into an appointed terminal according to the instruction of the Web server.

Further, without recording in communication server, the image and sound are transmitted to online terminal as well as to the Web server (20), and then stored and preserved as video album.

Next, it is described about the delivery of an appreciative letter to attended guest after the wedding reception. FIG. 34 illustrates an example of an appreciative letter to attended guests. As in the figure, a mail of the appreciative letter has an attachment of the image and sound or picture of the day of the wedding reception and delivered to each guest based on the attended guest table. Since the attached image and sound or picture is the same as in the appreciative letter to persons who have provided a donation for congratulation, the explanation therefor is omitted.

As to a return present of a wedding reception, since each attended guest registers a return present that he/she wants in the accepted guest table, delivery orders of the same goods which describes the name and address of the place to be delivered are automatically issued and sent to a designated delivery businessman according to the type of the goods.

Therefore, the host side has no necessity to prepare return presents to be given to guests in the hall of a wedding reception and the hall guest has no necessity to carry a heavy load to home. However, there may be persons who want to take a return present along with him/her, a delivery to home may be applied when a guest wants.

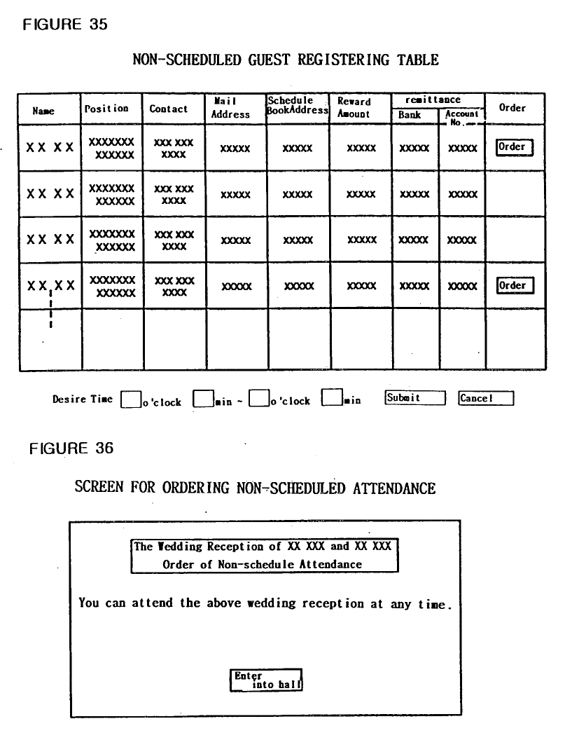

Lastly, it is explained about attendance function for non-scheduled attendance in the system for providing ceremonial occasion services of the present invention. A person of fame or an entertainer who accepts non-scheduled attendance, in a non-scheduled guest registering table as shown in FIG. 35, registers name, position, mail address, schedule book address, reward amount, if requested, remittance account, etc. Further, in the schedule book a time possible to attend is established.

When an MC or host call the non-scheduled guest registering table at the terminal, registered persons who can do non-scheduled attendance at the day are displayed. If the host or MC wants to designate a time that the non-scheduled guest attends at the ceremony, the host or MC can establish the time as a desire time. If a desire time is typed and sent, registered persons who can do a non-scheduled attendance at the desire time are searched and then a button of Order is displayed at the order column of the searched persons. Accordingly, when an MC or host searches persons who are registered in the non-scheduled guest table and clicks an Order button for a registered person who has coincident conditions, an order for non-scheduled attendance to the registered person is issued.

FIG. 36 illustrates an example of a screen for ordering non-scheduled attendance. An order screen displaying the above order of non-scheduled attendance and a button of Enter into hall is delivered via mail of HTML format. When the registered person receiving the above mail for ordering a non-scheduled attendance clicks, the terminal address of the registered person is registered at Connect to hall in the accepted guest table of communication server (24) and then connected to a hall terminal as an online guest. Accordingly, a person of fame or an entertainer, who is considered as nonattendance due to their busy schedule, can incidentally attend at the ceremony, and do a speech or entertainment via online. Further, it is described that the above screen for ordering non-scheduled attendance is delivered via mail, but it is possible to notice via web page when the terminal of the registered person is under login in the Web serve (20).

Further, to a registered person who did a non-scheduled attendance, a reward registered in a non-scheduled guest registering table are given and an automatic payment to the remittance bank account registered in the non-scheduled guest registering table. Accordingly, only if a person of fame or an entertainer registers a schedule capable of non-scheduled attendance and reward amount in a non-scheduled guest registering table, it is possible to unexpectedly attend at the ceremony according to the order of non-scheduled attendance to collect his/her guarantee automatically.

As such, the concept of providing a function of non-scheduled attendance to accept the non-scheduled attendance of a person of fame or entertainer can be considered as the secret of business by the businessmen of the ceremonial occasion services. Further, a politician of great caliber who is considered as bring glory to the ceremony that he attends can collect funds by using a short time and a young entertainer can earn money by utilizing this services. \

In the above embodiment, it is explained that the image and sound of online guest transmitted from each online terminal (81), (82) . . . are synthesized in the first-synthesis treatment of communication server (24) to be transmitted onto hall terminal (30), and the hall terminal (30) receives the synthesized image and sound and displays them as it is onto hall display (32) and hall speaker (34). However, the present invention is not necessarily limited to this embodiment, and it is possible to separately transmit the image and sound of each online terminal (81), (82) . . . into hall terminal (30) and to synthesize the image and sound of each online guest based on the selective synthesis information of said online guests to display onto hall display (32) and hall speaker (34).

Further, in the above embodiment, it is explained that the image and sound of a hall transmitted from hall terminal (30) the image and sound of online guest transmitted from each online terminal (81), (82) . . . are synthesized in the second-synthesis treatment of communication server (24) to be transmitted onto each online terminal (81), (82), . . . , (91), (92), . . . , and each online terminal (81), (82), . . . , (91), (92), . . . display the allotted image and sound as it is. However, the present invention is not necessarily limited to this embodiment and it is possible to transmit the image and sound of the hall transmitted from hall terminal onto each online terminal (81), (82), . . . , (91), (92), . . . , and separately transmit the image and sound of the online guest transmitted from each online terminal (81), (82), . . . onto other online terminal (81), (82), . . . , (91), (92), . . . , and simultaneously, to synthesize the image and sound of the hall and the image and sound of each online guest received in each online terminal (81), (82), . . . , (91), (92), . . . based on the selective synthesis information of said online guests to display it.

Further, as to the selective synthesis information of online guests, as described above, it is possible to transmit it to communication server (24) when a hall manager establishes a setting at the hall display, and then for the communication server (24) to allot it to each online terminal (81), (82), . . . , (91), (92), . . . , or it is possible to notify via Web server (24) or to directly notify from a hall terminal (30) to each connected online terminal.

Similarly, in the above embodiment, it is explained that the image and sound of waiting room connector transmitted from each waiting room connector terminal are synthesized in the third-synthesis treatment to be transmitted onto waiting room terminal (60) and the waiting room terminal (60) receives the synthesized image and sound and displays them as it is. However, the present invention is not necessarily limited to this embodiment, and it is possible to separately transmit the image and sound from each waiting room connector terminal into waiting room terminal and to synthesize the received image and sound of each waiting room connector to display it.

Similarly, in the above embodiment, it is explained that the image and sound of waiting room transmitted from waiting room terminal (60) and the image and sound of the waiting room connector transmitted from waiting room connector terminal are synthesized in the fourth-synthesis treatment and then transmitted onto waiting room terminal (60), and each waiting room connector terminal receives the synthesized image and sound and displays them as it is. However, the present invention is not necessarily limited to this embodiment, and it is possible to transmit the image and sound from each waiting room connector terminal into each waiting room connector terminal, and to separately transmit the image and sound of waiting room connector transmitted from each waiting room connector terminal into other waiting room connector terminal, and to synthesize the image and sound of the hall received from each waiting room connector terminal and image and sound of each waiting room connector to display it.

In the above embodiment, it is explained that, onto a hall display (32) and a hall speaker (34), the image and sound that obtained by synthesizing the image and sound of each online guest terminal are displayed, and onto each online terminal the image and sound that obtained by synthesizing the image and sound of the hall and the image and sound of each online guest, but it is possible to incorporated the image and sound of the hall into the image and sound to be displayed onto the hall display means. In such case, since it is sufficient to display the image and sound allotted to each online terminal onto the hall display means, the functions of the communication means can be simplified, and thus the load can be reduced. This is the same for the image and sound displayed in a waiting room terminal.

In the above embodiment, it is explained that conversion of hall camera and hall speaker, expression onto a hall display or a hall speaker, synthesis condition of the image and sound allotted onto each online terminal, and the like are done by a hall manager at the hall terminal. However, the present invention is not necessarily limited to this embodiment, and for example, it is possible for an MC to do it at a MC terminal. Accordingly, since an MC can control the arrangement and composition of the image and sound displayed on the hall display means or the image and sound displayed on each online terminal, a hall manager is not necessarily required and thus the ceremonial occasions can be held economically.

In the above embodiment, it is explained that a mouse is used as a pointing device in order to select various functional buttons or appoint a person with whom is wanted to have a conversation on an allotted screen or the like. However, the present invention is not necessarily limited to this embodiment, and for example, it is possible to stick a touch panel on a display of each online terminal to detect the position that the user has touched, by which a user can select the various functional buttons or can appoint a person with whom is wanted to have a conversation.

In the above embodiment, it is explained that an online guest individually attends the ceremonial occasion, but for example, the system can be constructed so that satellite halls for a ceremony which can receive multiple online guest are prepared on territory basis and the satellite hall is provided with a satellite display equipped with large size display, speaker, camera and microphone which can capture the image and sound of the whole satellite hall, camera and microphone which can capture the image and sound of an orator in the satellite hall, and by connecting via Internet with the system for providing ceremonial occasion services, the persons gathered in each satellite hall jointly attend a ceremony via online.

In such case, as in the terminal provided in tables at the hall of the above described ceremonial occasion, it is preferable to provide tables at the satellite hall with a terminal by which an individual television conversation with other online guest or hall guest, and thereby, it is possible to provide ceremonial occasion services under a similar environment to the case that the persons gathered in the satellite hall seats together at the hall to attend the ceremony.

In the above embodiment, it is explained that Web server, mail server and communication server are connected via network with hall terminal, MC terminal, front desk terminal, waiting room terminal and host terminal, but they are not necessarily placed in the same zone, and for example, may be dispersed and placed by using public phone lines or Internet.

Further, in the above embodiment, it is explained that the system for providing ceremonial occasion services of the present invention is connected with each online terminal via internet, but any communication means can be utilized as long as it has predetermined communication quality. For example, it is possible to utilize public phone lines, leased lines such as LAN or WAN owned by an enterprise or a local community, or satellite channel to connect with foreign countries or an out-of-the-way place.

In the above embodiment, it is explained that hall terminal (30) and communication server (24) are separately equipped, but the present invention is not necessarily limited to this embodiment, and it is possible to make them single body, for example to provide hall terminal with the function of communication server.

Further, as long as the method for providing ceremonial occasion services comprises the following steps: a step of accepting an online guest who attends said ceremony via online, a step of connecting, as online guest, each online terminal used by the above accepted online guest, a step of receiving image and sound of each online guest transmitted from each online terminal which has been connected as said online guest, a first-synthesis step of synthesizing the above received image and sound of each online guest, a step of displaying the image and sound synthesized by the above first-synthesis step function within a hall in which said ceremony is held, a step of obtaining image and sound of the hall, a second-synthesis step of synthesizing the above obtained image and sound of the hall and the above received image and sound of each online guest, a step of allotting the image and sound synthesized by the above second-synthesis step onto each online terminal connected as an online guest, the method comprising any device or constitution can be allowed and may achieve the effect of the present invention.

Further, in the above embodiment, it is possible to allot the received image and sound to each accessed online terminal, and at the same time, to separately allot the received image and sound of each online guest to other accessed online terminal, and the second-synthesis step may be provided to each online terminal, which achieves the effect of the present invention.

In the above embodiment, it is explained that a personal computer having a videophone function is used as each online terminal, but the present invention is not limited to this embodiment, and for example, it is possible to use a portable telephone or handheld terminal having a videophone function to attend a ceremony via online.

Further, it is possible to connect using a public videophone system, or it is possible to prepare a telephone service center or videophone service counter in each local stronghold to accept the online attendance services of ceremonial occasion.

In the above embodiment, it is explained that the acceptance of donation for congratulation is separately performed from the acceptance of attendance at a wedding reception, but it is possible to accept a donation when accepting the attendance or when accepting a reply of attendance to register it in a accepted guest table or invited guest table. Accordingly, since the acceptance of donation from general persons and the acceptance of donation from accepted guest are clearly divided and treated, it is possible to obtain the information about acceptance of donation a accepted guest even in the case where the selection of a return present or the order of delivery of foods are carried out according to the amount of a donation for congratulation.

In the above embodiment, it is explained that a wedding reception is exemplified as a ceremony, but the present invention is not limited to this embodiment, and it is applied to funeral, other religious celebration or the like and same effect can be obtained. Especially, it is difficult for persons who want to attend the funeral to adjust their schedule since a funeral generally happen in sudden, and therefore, it is thought that there is a high demand for such services. Further, as to a funeral, a message of congratulation is replaced with a message of condolence, a donation for congratulation with a donation for condolence, and a return present with an offered food.

### EFFECTS OF THE INVENTION

As described above, according to the present invention, since it is possible for guests present in the hall to visually recognize each online guest, and simultaneously, for each online guest to visually recognize the hall and other online guest, the system and method of the present invention can provide a similar sensation to the case where each online guest attends and seats together with them at the hall.

What is claimed is:

1. System for providing ceremonial occasion services enabling to attend a ceremony via online by using an online terminal unit having a videophone function, characterized by that it comprises:
a hall image and sound acquisition means for obtaining image and sound of a hall in which said ceremony is held,
a hall display means for displaying image and sound of an online guest who attends said ceremony via online to the hall,
a guest acceptance means for accepting the attendance of an online guest who wants to attend the ceremony via online, and
a communication means having a function of connecting as an online guest an online terminal used by the online guest who has been accepted by said guest acceptance means, a function of receiving the image and sound of each online guest transmitted from each online terminal connected as said online guest, a first-synthesis function of synthesizing the above received image and sound of each online guest, a function of transmitting the image and sound synthesized by the above first-synthesis function onto said hall display means, a function of receiving the image and sound of the hall transmitted from said hall image and sound acquisition means, a second-synthesis function of synthesizing the above received image and sound of hall and the above received image and sound of each online guest, a function of allotting the image and sound synthesized by the above second-synthesis function onto each online terminal connected as an online guest.

2. System for providing ceremonial occasion services according to claim 1, characterized in that it comprises a visitor acceptance means for accepting a visitor who watches said ceremony via online, and
said communication means has a function of connecting as an online visitor an online terminal used by the visitor accepted by the above visitor acceptance means and a function of allotting the image and sound synthesized by said second-synthesis function onto each online terminal connected as an online visitor.

3. System for providing ceremonial occasion services according to claim 1, characterized in that a reception room terminal having a videophone function is provided in a reception room for guests of said ceremony, and
said communication means has a function of connecting an online terminal used by the accepted online guest with said reception room terminal, a function of receiving image and sound of each reception room connector which are transmitted from each online terminal connected with said reception room terminal, a third-synthesis function of synthesizing the above received image and sound of each reception room connector, a function of transmitting the image and sound synthesized by the third-synthesis function onto said reception room terminal, a function of receiving the image and sound of the reception room transmitted from the reception room terminal, a fourth-synthesis function of synthesizing the above received image and sound of the reception room and the above received image and sound of each reception room connector, a function of allotting the image and sound synthesized by the fourth-synthesis function to each online terminal connected with said reception room terminal.

4. System for providing ceremonial occasion services enabling to attend at a ceremony via online by using an online terminal unit having a videophone function, characterized by that it comprises:
a hall image and sound acquisition means for obtaining image and sound of a hall in which said ceremony is held,
a hall display means for displaying, at the hall, image and sound of a person who attends said ceremony via online,
an guest acceptance means for accepting the attendance of an online guest who want to attend the ceremony via online, and
a communication means having a function of connecting as an online guest each online terminal used by each online guest who has been accepted by said guest acceptance means, a function of receiving the image and sound of each online guest transmitted from each online terminal connected as said online guest, a function of transmitting the above received image and sound of each online guest onto said hall display means, a function of receiving the image and sound of the hall transmitted from said hall image and sound acquisition means, a function of allotting the above received image and sound onto each online terminal connected as an online guest, and a function of allotting the above allotted image and sound of each online guest onto other online terminal connected as an online guest,
wherein said hall display means has a first-synthesis function of synthesizing the image and sound of each online guest transmitted from said communication means, and
wherein the online terminal connected as said online guest has a second synthesis function of synthesizing the image and sound of the hall transmitted from said communication means and the image and sound of other online guest transmitted from said communication means.

5. System for providing ceremonial occasion services according to claim 4, characterized in that it comprises a visitor acceptance means for accepting a visitor who watches said ceremony via online, an
said communication means has a function of connecting as an online visitor each online terminal used by each visitor accepted by said visitor acceptance means and a function of allotting the image and sound equivalent to those allotted to each online terminal connected as an online guest onto each online terminal connected as an online visitor,
wherein each online terminal connected as an online visitor has a function equivalent to the second-synthesis function which each online terminal connected as said online guest possesses.

6. System for providing ceremonial occasion services according to claim 4, characterized in that a reception room terminal having a videophone function is provided in a reception room for guests of said ceremony, and
said communication means has a function of connecting an online terminal used by the accepted online guest with said reception room terminal, a function of receiving image and sound of each waiting room connector which are transmitted from each online terminal connected with said waiting room terminal, a function of transmitting the above received image and sound of each reception room connector onto said reception room terminal, a function of receiving the image and sound of the reception room transmitted from the reception room terminal, a function of allotting the above received image and sound of the reception room onto each online terminal connected to said reception room terminal, and a function of allotting the above received image and sound of the reception room onto other online terminal connected to said reception room terminal,
wherein said reception room terminal has a third-synthesis function of synthesizing the image and sound of each reception room connector transmitted from said communication means,
wherein each online terminal connected to said reception room terminal has a fourth-synthesis function of synthesizing the image and sound of reception room allotted from said communication means and the image and sound of each reception room connector allotted from said communication means.

7. System for providing ceremonial occasion services according to claim 1, characterized in that said first- and second-synthesis function has a function of changing the composition ratio of image and sound to be synthesized on the basis of the instruction from the terminal provided in the hall.

8. System for providing ceremonial occasion services according to claim 1, characterized in that said hall image and sound acquisition means has a function of acquiring multiple sounds and images of the hall, and a function of selecting and synthesizing a specific image and sound from the above acquired multiple sounds and images based on the instruction from a terminal installed in the hall.

9. System for providing ceremonial occasion services according to claim 1, characterized in that said online terminal comprises a call means having a function of acquiring a position on the allotted screen which is assigned by a guest by means of a pointing device, a function of selecting a called terminal from the above acquired position on the allotted screen, and a function of displaying a call screen onto the called terminal, and
said communication means has a function of connecting, when a guest who has been called responses the above call screen to accept an individual interview, a terminal used by a guest who wants the individual interview with the above selected terminal which has been called.

10. System for providing ceremonial occasion services according to claim 9, characterized in that said call means has a function of displaying, onto the hall terminal, a call screen which shows the above acquired position on the allotted screen when said acquired position on the allotted screen lies in the hall,
said communication means has a function of connecting, when a hall guest who has been designated responses the above call screen to accept an individual interview, a terminal used by a guest who wants the individual interview with the hall terminal.

11. System for providing ceremonial occasion services, according to claim 1, characterized in that the usher's desk of the ceremony hall is provided with an usher's desk terminal,
said usher's desk terminal has a function of accepting the attendance of hall guest at the above ceremony hall.

12. System for providing ceremonial occasion services according to claim 11, characterized in that said usher's desk terminal has a videophone function, and
said communication means has a function of connecting an online terminal used by said online guest to the above usher's desk terminal.

13. System for providing ceremonial occasion services according to claim 1, characterized in that said guest acceptance means has a function of generating a table of invited guests in which the invited guests are registered with any personal information, a function of issuing a guest ID for a guest registered in the above table of invited guests, a function of issuing a letter of invitation which describes an URL of a Web site receiving an reply for an attendance or nonattendance and the above issued guest ID to each invited guest registered in said table of invited guests, a function of confirming, when an invited guest who had received the above issued letter of invitation accesses and enters the Web site having the notified URL by using the notified guest ID, his/her personal information registered in the table of invited guests, and a function of registering the inputted reply of attendance or nonattendance on the table of invited guests.

14. System for providing ceremonial occasion services according to claim 13, said guest acceptance means has a function of registering a request for speech or entertainment to an invited guest registered on the table of invited guest, a function of issuing a letter of invitation which describes the above request to the guest to whom the above request for speech or entertainment has been registered, and a function of registering the yes or no reply to the request for speech or entertainment by the guest who has received the letter of invitation describing a request for speech or entertainment.

15. System for providing ceremonial occasion services according to claim 13, characterized in that said guest acceptance means has a function of accepting, when an invited guest who has registered his reply for the attendance to the above ceremony accesses the Web site by using his guest ID, the attendance of the guest.

16. System for providing ceremonial occasion services according to claim 13, characterized in that said guest acceptance means has a function of sending an attendance accepting guide to an invited guest who has registered his reply for the attendance to the above ceremony and a function of accepting, when an attendance button provided in the above attendance accepting guide is clicked, the attendance of the invited guest.

17. System for providing ceremonial occasion services according to claim 1, characterized in that said guest acceptance means has a function of making an electronic entry by receiving image and sound transmitted from said each online terminal and leaving them as guest's record.

18. System for providing ceremonial occasion services according to claim 1, characterized in that said guest acceptance means has a function of accepting a donation for congratulation or funeral expenses when an attendance is accepted, a function of registering the amount of the above accepted donation, a function of selecting a return present or an offered food based on the amount of the above registered donation, and a function of outputting a delivery order which delivers the above selected return present or the offered food.

19. System for providing ceremonial occasion services according to claim 1, characterized in that said guest acceptance means has a function of asking whether to want an express delivery service of the food or not to an online guest, a function of selecting, when the online guest wants the express delivery service of the food, a businessman of the express delivery service based on the address of the online guest, a function of sending the above selected businessman a delivery order which describes the address of the online guest who has replied to want an express delivery service of the food, the time when the ceremony starts and the like.

20. System for providing ceremonial occasion services according to claim 1, characterized in that said guest acceptance means has a function of sending an entrance guide into the ceremony hall to each online guest whose attendance has been accepted, and
said communication means has a function of connecting as an online guest the online terminal of the online guest when a button for the entrance into the hall provided in the above entrance guide is clicked.

21. System for providing ceremonial occasion services according to claim 1, characterized in that it comprise an MC terminal used by a MC (master of ceremonies) of the ceremony, and
the above MC terminal has a function of displaying a time table for proceeding the ceremony which describes the order and model sentences uttered by the MC of the above ceremony.

22. System for providing ceremonial occasion services according to claim 21, characterized in that said MC terminal has a function of displaying a table of attended guests which records at least personal information and attendance status of guests whose attendance has been accepted.

23. System for providing ceremonial occasion services according to claim 21, characterized in that said MC terminal has a function of displaying the predetermined connection time of the online guest whose attendance has been accepted.

24. System for providing ceremonial occasion services to claim 21, characterized in that said MC terminal has a function of displaying a message registering table for registering the received messages of congratulation or condolence and a function of regenerating and sending, when a replay button provided on the above displayed message registering table, the selected messages of congratulation or condolence to said communication means, and
said communication means has a function of receiving the message transmitted from the above MC terminal, a function of transmitting the above received message onto said hall display means, and a function of allotting the above received message onto said each online terminal.

25. System for providing ceremonial occasion services according to claim 21, characterized in that said guest acceptance means has a function of asking said accepted guest for a speech or entertainment, a function of registering the reply of yes or no to the above question, and
said MC terminal has a function of displaying the above registered reply.

26. System for providing ceremonial occasion services according to claim 21, characterized in that said MC terminal has a videophone function, and
said communication means has a function of connecting an online terminal whose attendance has been accepted to the above MC terminal.

27. System for providing ceremonial occasion services according to claim 1, characterized in that it comprises a host terminal used by the host of the ceremony and said host terminal has a videophone function, and
said communication means has a function of connecting an online terminal whose attendance has been accepted to the above host terminal.

28. System for providing ceremonial occasion services according to claim 1, characterized in that, as to the image allotted onto said each online terminal, it comprises a commemorative photograph recording means for recording an image of frame designated from a terminal set up in the hall as a commemorative photograph.

29. System for providing ceremonial occasion services according to claim 1, characterized in that it comprises a means for recording and allotting a video album, which has a function of recording image and sound allotted onto said each online terminal as a video album and a function of allotting the above recorded video album via on-demand manner.

30. System for providing ceremonial occasion services according to claim 1, wherein it comprises a means for accepting a message of congratulation or condolence which is provided with a table for registering the message and has a function of accepting an application of the message, a function of registering the personal information of the above registered applicant of the message onto the table for registering the message, and a function of registering the message onto the table for registering the message,
characterized in that it has a function of registering image and sound transmitted from an online terminal having a videophone function as a message of congratulation or condolence.

31. System for providing ceremonial occasion services according to claim 30, characterized in that said means for accepting a message of congratulation or condolence has a function of editing the content of the message of congratulation or condolence.

32. System for providing ceremonial occasion services according to claim 1, characterized in that it comprises a donation accepting means for accepting a donation for congratulation or funeral expenses, which is provided with a donation registering table for registering the donation and has a function of accepting an application of the above donation, a function of registering personal information of the above accepted applicant, the payment method and the amount of money onto the donation registering table, and a function of asking the applicant for payment based on the payment method registered in the above donation registering table.

33. System for providing ceremonial occasion services according to claim 32, characterized in that said donation accepting means is provided with a donation-refusal table for registering persons whose donation for congratulation or funeral expenses would be refused, and said function of accepting an application of the donation includes a function of refusing the application of the donation based on the above donation-refusal table.

34. System for providing ceremonial occasion services according to claim 32, characterized in that said donation accepting means has a function of delivering an appreciative letter to applicants registered on said donation-refusal table, a function of selecting a return present based on the amount registered in the above donation-refusal table, and a function of outputting a delivery order which delivers the selected return present to the applicant registered on said donation-refusal table.

35. System for providing ceremonial occasion services according to claim 32, characterized in that said donation accepting means has a function of find a total of the above requested payment amount and a function of doing the payment for the ceremony from the above total amount.

36. System for providing ceremonial occasion services according to claim 1, characterized in that it comprises a mail sending means having a function of generating an appreciative letter attached with image and sound or video image recorded at the ceremony and a function of delivering the above generated appreciative letter to guests who attended the ceremony.

37. System for providing ceremonial occasion services according to claim 1, characterized in that it comprises a means for ordering a non-scheduled attendance which is provided with a non-scheduled guest accepting table for accepting persons who have been designated and attend the ceremony via online, and has a function of confirming the schedule of a person registered in the above non-scheduled guest accepting table, a function of selecting a person who is capable of unexpectedly attending the ceremony based on the confirmed schedule, and a function of issuing an order for non-scheduled attendance to the above selected person, and at the same time,
said communication means has a function of connecting as an online guest, when a non-scheduled guest ordered by the above means for ordering a non-scheduled attendance attends the ceremony, the online terminal used by the non-scheduled guest.

38. System for providing ceremonial occasion services according to claim 37, characterized in that said non-scheduled guest accepting table can register a reward amount for a non-scheduled attendance of the registered person,
wherein it comprises a means for paying a reward of a non-scheduled guest which pays the reward amount registered in the above non-scheduled guest accepting table when a non-scheduled person ordered by said means for ordering a non-scheduled attendance attends the ceremony.

39. Method for providing ceremonial occasion services enabling to attend at a ceremony via online by using an online terminal unit having a videophone function, characterized by that it comprises:
a step of accepting an online guest who attends said ceremony via online,
a step of connecting, as online guest, each online terminal used by the above accepted online guest,
a step of receiving image and sound of each online guest transmitted from each online terminal which has been connected as said online guest,
a first-synthesis step of synthesizing the above received image and sound of each online guest,
a step of displaying the image and sound synthesized by the above first-synthesis step function within a hall in which said ceremony is held,
a step of obtaining image and sound of the hall,
a second-synthesis step of synthesizing the above obtained image and sound of the hall and the above received image and sound of each online guest,
a step of allotting the image and sound synthesized by the above second-synthesis step onto each online terminal connected as an online guest.

40. Method for providing ceremonial occasion services enabling to attend at a ceremony via online by using an online terminal unit having a videophone function, characterized by that it comprises:
a step of accepting an online guest who attends said ceremony via online,
a step of connecting, as online guest, each online terminal used by the above accepted online guest,
a step of receiving image and sound of each online guest transmitted from each online terminal which has been connected as said online guest,
a first-synthesis step of synthesizing the above received image and sound of each online guest,
a step of displaying the image and sound synthesized by the above first-synthesis step function within a hall in which said ceremony is held,
a step of obtaining image and sound of the hall,
a step of allotting the above obtained image and sound of the hall onto each online terminal connected as an online guest, and
a step of allotting the received image and sound of each online guest onto other online terminal connected as the above online guest,
wherein each online terminal connected as said online guest has a second-synthesis step of synthesizing the above allotted image and sound of the hall and the above allotted image and sound of other online guest.
